(19) United States
(12) Patent Application Publication
(10) Pub. No.: US 2016/0350664 A1
(43) Pub. Date: Dec. 1, 2016

(54) VISUALIZATIONS FOR ELECTRONIC NARRATIVE ANALYTICS

(71) Applicants: SAS Institute Inc., Cary, NC (US); North Carolina State University, Raleigh, NC (US)

(72) Inventors: Ravinder Devarajan, Cary, NC (US); Jordan Riley Benson, Ellerbe, NC (US); David James Caira, Chapel Hill, NC (US); Saratendu Sethi, Raleigh, NC (US); James Allen Cox, Cary, NC (US); Christopher G. Healey, Cary, NC (US); Gowtham Dinakaran, Raleigh, NC (US); Kalpesh Padia, Raleigh, NC (US); Shaoliang Nie, Raleigh, NC (US)

(21) Appl. No.: 15/177,237

(22) Filed: Jun. 8, 2016

Related U.S. Application Data
(63) Continuation-in-part of application No. 14/966,117, filed on Dec. 11, 2015.
(60) Provisional application No. 62/190,723, filed on Jul. 9, 2015.

(30) Foreign Application Priority Data
May 29, 2015 (IN) 1551/DEL/2015
Oct. 27, 2015 (IN) 3483/DEL/2015

(51) Int. Cl. G06N 5/04; G06F 17/27; G06F 17/30; G06N 99/00

(52) U.S. Cl. CPC G06N 5/047; G06N 99/005; G06F 17/2735; G06F 17/2775; G06F 17/30716

(57) ABSTRACT

The results of electronic narrative analytics can be visualized. For example, an electronic communication that includes multiple narratives can be received. Each narrative can be segmented into respective blocks of characters. Multiple sentiments associated with the respective blocks of characters can be determined. Multiple sentiment patterns can be determined based on the multiple sentiments. The multiple sentiment patterns can be categorized into multiple sentiment pattern groups. Also, multiple semantic tags associated with the multiple sentiment patterns can be determined. Further, the multiple narratives can be categorized into multiple topic sets. A graphical user interface can be displayed visually indicating at least a portion of: the multiple sentiments, the multiple sentiment pattern groups, the multiple semantic tags, or the multiple topic sets.

### REFERENCE TO RELATED APPLICATIONS

This claims the benefit of priority under 35 U.S.C. §119(b) to Indian Provisional Patent Application No. 3483/DEL/2015, titled “Level-of-Detail Visualization for Text Narrative Analytics” and filed Oct. 27, 2015, and under 35 U.S.C. §120 as a continuation-in-part of co-pending U.S. patent application Ser. No. 14/966,117, titled “Automatically Constructing Training Sets for Electronic Sentiment Analysis” and filed Dec. 11, 2015, which claims the benefit of priority under 35 U.S.C. §119(e) to U.S. Provisional Patent Application No. 62/190,723, titled “Automatic Construction of Training Sets for Computerized Text Sentiment Analysis” and filed Jul. 9, 2015, and the benefit of priority under 35 U.S.C. §119(b) to Indian Provisional Patent Application No. 1551/DEL/2015, titled “Automatic Construction of Training Sets for Computerized Text Sentiment Analysis” and filed May 29, 2015, the entirety of each of which is hereby incorporated by reference herein.

### TECHNICAL FIELD

The present disclosure relates generally to graphical user interfaces. More specifically, but not by way of limitation, this disclosure relates to visualizations for electronic narrative analytics.

### BACKGROUND

With the rise of the Internet and mobile electronic devices, users are generating increasing amounts of electronic content. Electronic content often takes the form of forum posts, text messages, social networking posts, blog posts, e-mails, chatroom discussions, or other electronic communications. In many cases, users express their sentiment (e.g., opinion, feeling, emotion, or attitude) about a thing, company, or other topic within the electronic content.

### SUMMARY

In one example, a computer readable medium comprising program code executable by a processor is provided. The program code can cause the processor to receive an electronic communication comprising a plurality of narratives. The program code can cause the processor to segment each narrative of the plurality of narratives into respective blocks of characters. The program code can cause the processor to determine a plurality of sentiments associated with the respective blocks of characters using a sentiment dictionary. Each sentiment of the plurality of sentiments can correspond to a particular block of characters. The program code can cause the processor to determine a plurality of sentiment patterns based on the plurality of sentiments. Each sentiment pattern of the plurality of sentiment patterns can correspond to a respective narrative of the plurality of narratives. Each sentiment pattern of the plurality of sentiment patterns can comprise a plurality of sentiment blocks ordered in an arrangement corresponding to the respective blocks of characters associated with the respective narrative. Each sentiment block of the plurality of sentiment blocks can indicate one or more sentiments of the plurality of sentiments. The program code can cause the processor to determine a plurality of semantic tags associated with the plurality of sentiment patterns. Each semantic tag of the plurality of semantic tags can correspond to a respective sentiment block of the plurality of sentiment blocks and represent of content associated with the respective sentiment block. The program code can cause the processor to categorize the plurality of narratives into a plurality of topic sets. Each topic set of the plurality of topic sets can comprise one or more narratives having a common topic. The program code can cause the processor to determine a plurality of overall sentiments based on the plurality of topic sets. Each overall sentiment of the plurality of overall sentiments can correspond to a respective topic set of the plurality of topic sets and indicate a total sentiment among one or more narratives associated with the respective topic set. The program code can cause the processor to categorize the plurality of sentiment patterns into a plurality of sentiment pattern groups. Each sentiment pattern group of the plurality of sentiment pattern groups can be associated with a unique sentiment pattern of the plurality of sentiment patterns. The program code can cause the processor to determine a similarity between at least two sentiment pattern groups of the plurality of sentiment pattern groups. The program code can cause the processor to transmit graphical information configured to cause a display to output a graphical user interface visually indicating at least a portion of: the plurality of sentiments, the plurality of sentiment pattern groups, the plurality of semantic tags, or the plurality of topic sets.

In another example, a method is provided that can include receiving an electronic communication comprising a plurality of narratives. The method can include segmenting each narrative of the plurality of narratives into respective blocks of characters. The method can include determining a plurality of sentiments associated with the respective blocks of characters using a sentiment dictionary. Each sentiment of the plurality of sentiments can correspond to a particular block of characters. The method can include determining a plurality of sentiment patterns based on the plurality of sentiments. Each sentiment pattern of the plurality of sentiment patterns can correspond to a respective narrative of the plurality of narratives. Each sentiment pattern of the plurality of sentiment patterns can comprise a plurality of sentiment blocks ordered in an arrangement corresponding to the respective blocks of characters associated with the respective narrative. Each sentiment block of the plurality of sentiment blocks can indicate one or more sentiments of the plurality of sentiments. The method can include determining a plurality of semantic tags associated with the plurality of sentiment patterns. Each semantic tag of the plurality of semantic tags can correspond to a respective sentiment block of the plurality of sentiment blocks and represent of content associated with the respective sentiment block. The method can include categorizing the plurality of narratives into a plurality of topic sets. Each topic set of the plurality of topic sets can comprise one or more narratives having a common topic. The method can include determining a plurality of overall sentiments based on the plurality of topic sets. Each overall sentiment of the plurality of overall sentiments can correspond to a respective topic set of the plurality of topic sets and indicate a total sentiment among one or more narratives associated with the respective topic set. The method can include categorizing the plurality of sentiment patterns into a plurality of sentiment pattern groups. Each sentiment pattern group of the plurality of sentiment pattern groups can be associated with a unique sentiment pattern of the plurality of sentiment patterns. The method can include determining a similarity between at least two sentiment pattern groups of the plurality of sentiment pattern groups. The method can include transmitting graphical information configured to cause a display to output a graphical user interface visually indicating at least a portion of: the plurality of sentiments, the plurality of sentiment pattern groups, the plurality of semantic tags, or the plurality of topic sets.

In another example, a system is provided that can include a processing device and a memory device. The memory device can include instructions executable by the processing device for causing the processing device to receive an electronic communication comprising a plurality of narratives. The instructions can cause the processing device to segment each narrative of the plurality of narratives into respective blocks of characters. The instructions can cause the processing device to determine a plurality of sentiments associated with the respective blocks of characters using a sentiment dictionary. Each sentiment of the plurality of sentiments can correspond to a particular block of characters. The instructions can cause the processing device to determine a plurality of sentiment patterns based on the plurality of sentiments. Each sentiment pattern of the plurality of sentiment patterns can correspond to a respective narrative of the plurality of narratives. Each sentiment pattern of the plurality of sentiment patterns can comprise a plurality of sentiment blocks ordered in an arrangement corresponding to the respective blocks of characters associated with the respective narrative. Each sentiment block of the plurality of sentiment blocks can indicate one or more sentiments of the plurality of sentiments. The instructions can cause the processing device to determine a plurality of semantic tags associated with the plurality of sentiment patterns. Each semantic tag of the plurality of semantic tags can correspond to a respective sentiment block of the plurality of sentiment blocks and represent of content associated with the respective sentiment block. The instructions can cause the processing device to categorize the plurality of narratives into a plurality of topic sets. Each topic set of the plurality of topic sets can comprise one or more narratives having a common topic. The instructions can cause the processing device to determine a plurality of overall sentiments based on the plurality of topic sets. Each overall sentiment of the plurality of overall sentiments can correspond to a respective topic set of the plurality of topic sets and indicate a total sentiment among one or more narratives associated with the respective topic set. The instructions can cause the processing device to categorize the plurality of sentiment patterns into a plurality of sentiment pattern groups. Each sentiment pattern group of the plurality of sentiment pattern groups can be associated with a unique sentiment pattern of the plurality of sentiment patterns. The instructions can cause the processing device to determine a similarity between at least two sentiment pattern groups of the plurality of sentiment pattern groups. The instructions can cause the processing device to transmit graphical information configured to cause a display to output a graphical user interface visually indicating at least a portion of: the plurality of sentiments, the plurality of sentiment pattern groups, the plurality of semantic tags, or the plurality of topic sets.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

The present disclosure is described in conjunction with the appended figures:

FIG. 1 is a block diagram of an example of the hardware components of a computing system according to some aspects.

FIG. 2 is an example of devices that can communicate with each other over an exchange system and via a network according to some aspects.

FIG. 3 is a block diagram of a model of an example of a communications protocol system according to some aspects.

FIG. 4 is a hierarchical diagram of an example of a communications grid computing system including a variety of control and worker nodes according to some aspects.

FIG. 5 is a flow chart of an example of a process for automatically constructing training sets for electronic sentiment analysis according to some aspects.

FIG. 6 is a flow chart of an example of a process for determining a total sentiment score for a block of characters according to some aspects.

FIG. 7 is a table showing an example of blocks of characters and their corresponding overall sentiments according to some aspects.

FIG. 8 is an example of a graphical user interface (GUI) showing multiple sentiments associated with a chat session between two users according to some aspects.

FIG. 9 is a flow chart of an example of a process for generating a GUI according to some aspects.

FIG. 10 is a flow chart of an example of another process for generating a GUI according to some aspects.

FIG. 11 is an example of a GUI showing multiple sentiments associated with a chat session according to some aspects.

FIG. 12 is a flow chart of an example of a process for providing visualizations for electronic narrative analytics according to some aspects.

FIG. 13 is a flow chart of an example of a process for determining a sentiment for a block of characters according to some aspects.

FIG. 14 is a flow chart of an example of a process for determining sentiment patterns according to some aspects.

FIG. 15 is a flow chart of an example of a process for determining semantic tags for semantic blocks according to some aspects.

FIG. 16 is a flow chart of an example of a process for determining an overall sentiment for a topic set according to some aspects.

FIG. 17 is a flow chart of an example of a process for determining a similarity between sentiment pattern groups according to some aspects.

FIG. 18 is an example of a dissimilarity matrix according to some aspects.

FIG. 19 is an example of a graphical user interface (GUI) showing multiple stream graphs associated with topic sets according to some aspects.

FIG. 20 is an example of the GUI of FIG. 19 in which a particular topic set is hovered over according to some aspects.

FIG. 21 is an example of a GUI showing sentiment pattern groups associated with a particular topic set according to some aspects.

FIG. 22 is an example of the GUI of FIG. 21 in which a particular sentiment pattern group is hovered over according to some aspects.

FIG. 23 is an example of a GUI showing semantic patterns associated with narratives in a particular sentiment pattern group according to some aspects.

FIG. 24 is an example of a GUI showing sentiments of a specific narrative within a particular sentiment pattern group according to some aspects.

In the appended figures, similar components or features can have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of examples of the technology. But various examples can be practiced without these specific details. The figures and description are not intended to be restrictive.

The ensuing description provides examples only, and is not intended to limit the scope, applicability, or configuration of the disclosure. Rather, the ensuing description of the examples provides those skilled in the art with an enabling description for implementing an example. Various changes may be made in the function and arrangement of elements without departing from the spirit and scope of the technology as set forth in the appended claims.

Specific details are given in the following description to provide a thorough understanding of the examples. But the examples may be practiced without these specific details. For example, circuits, systems, networks, processes, and other components can be shown as components in block diagram form to prevent obscuring the examples in unnecessary detail. In other examples, well-known circuits, processes, algorithms, structures, and techniques may be shown without unnecessary detail in order to avoid obscuring the examples.

Also, individual examples can be described as a process that is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but can have additional operations not included in a figure. A process can correspond to a method, a function, a procedure, a subroutine, a subprogram, etc. When a process corresponds to a function, its termination can correspond to a return of the function to the calling function or the main function.

Systems depicted in some of the figures can be provided in various configurations. In some examples, the systems can be configured as a distributed system where one or more components of the system are distributed across one or more networks in a cloud computing system.

Certain aspects and features of the present disclosure relate to automatically constructing a training set for electronic sentiment analysis. A computing device can automatically construct the training set using data from multiple electronic communications. Examples of an electronic communication can include a text message, an e-mail, an electronic document, a social media post (e.g., a Twitter™ tweet, a Facebook™ post, etc.), a blog post, a forum post, a chat log, or any combination of these. In some examples, for each electronic communication, the computing device can break the electronic communication up into smaller segments, determine a total sentiment score associated with each segment using a sentiment dictionary, and aggregate the total sentiment scores from all of the segments to determine an aggregate sentiment score for the electronic document. Based on the aggregate sentiment score, the computing device can determine an overall sentiment (e.g., a positive sentiment, a negative sentiment, or a neutral sentiment) associated with the electronic communication. The computing device can include multiple electronic communications, their associated aggregate sentiment scores, their associated overall sentiments, or any combination of these in a data set. The data set can be used for training a sentiment analysis program (e.g., for training classification system of a sentiment analysis program).

In some examples, the sentiment analysis program can perform sentiment analysis on another (e.g., a new) electronic communication that includes one or more unknown sentiments. The sentiment analysis program can determine and provide one or more predicted sentiments associated with the electronic communication.

Further, certain aspects and features of the present disclosure relate to graphical user interfaces (GUI) and visualizations for analyzing one or more electronic narratives. A computing device can analyze the electronic narratives and cause information about the electronic narratives to be displayed via a GUI.

In some examples, the GUI can include predicted sentiments represented as points on a graph, such as a line graph. The points can be positioned on the graph such that each point indicates whether the point corresponds to a positive sentiment, a neutral sentiment, or a negative sentiment. Transitions between points can indicate transitions between sentiments. For example, a transition from a point indicating a positive sentiment to another point indicating a negative sentiment can represent a transition from the positive sentiment to the negative sentiment.

In some examples, a user can interact with the GUI. For example, a user can click on a point on the graph. The GUI can display a graphical object, such as a comment bubble, in response to the click. In some examples, the graphical object can include information associated with the point. As another example, a user can drag a point on the graph from a first location on the graph to a second location on the graph. The first location can correspond to an incorrect sentiment and the second location can correspond to a correct sentiment. Thus, the user can drag the point from the first location to the second location to correct the sentiment indicated by the point. In some examples, the data set used to train the sentiment analysis program can be updated based on the corrected sentiment, and the sentiment analysis program can be retrained using the updated data set. This can provide a feedback loop in which the sentiment analysis program can predict sentiments, the user can correct erroneous sentiment predictions, and the sentiment analysis program can be retrained based on the user's corrections to become more accurate.

In some examples, the GUI can be a multi-layered GUI. The multi-layered GUI can include a first layer that can include topics, frequencies of topics, and sentiments of topics over time associated with multiple electronic narratives. The multi-layer GUI can receive a user input and responsively display a second layer that can include sentiment pattern groups associated with a particular topic and similarities between the sentiment pattern groups. The multi-layer GUI can receive a user input and responsively display a third layer that can include sentiment tags associated with narratives in an individual sentiment pattern group. The multi-layer GUI can receive a user input and responsively display a fourth layer that can include a line graph indicating sentiment transitions within a particular narrative.

The multi-layered GUI can include any number and combination of layers, and each layer can include more, less, or different information than described above. The computing device can cause the layers to be displayed in any order and in response to any user input or combination of user inputs.

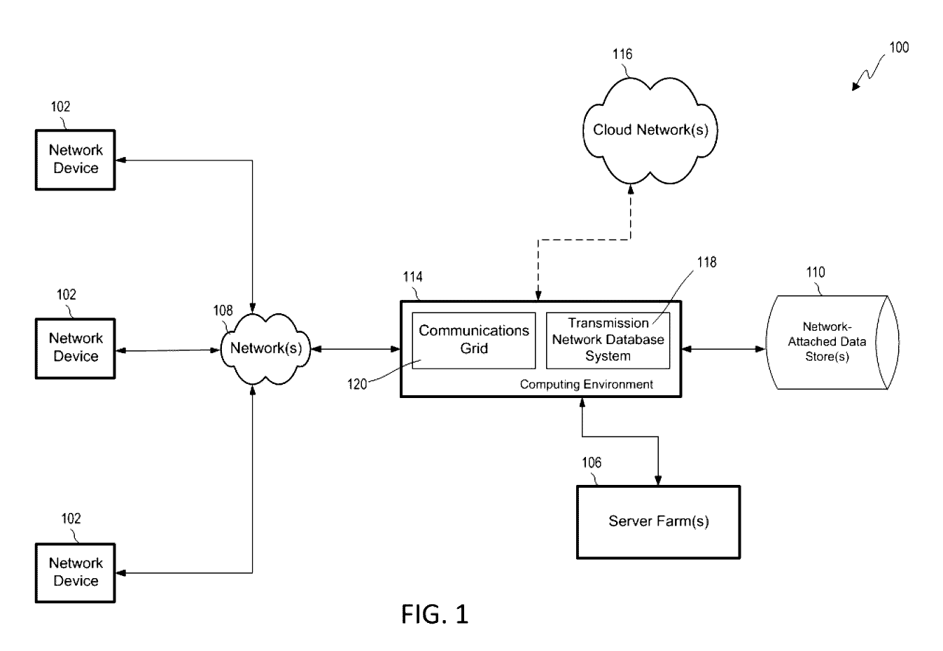

FIGS. 1-4 depict examples of systems usable for implementing any feature or combination of features described in the present disclosure. For example, FIG. 1 is a block diagram of an example of the hardware components of a computing system according to some aspects. Data transmission network 100 is a specialized computer system that may be used for processing large amounts of data where a large number of computer processing cycles are required.

Data transmission network 100 may also include computing environment 114. Computing environment 114 may be a specialized computer or other machine that processes the data received within the data transmission network 100. The computing environment 114 may include one or more other systems. For example, computing environment 114 may include a database system 118 or a communications grid 120.

Data transmission network 100 also includes one or more network devices 102. Network devices 102 may include client devices that can communicate with computing environment 114. For example, network devices 102 may send data to the computing environment 114 to be processed, may send communications to the computing environment 114 to control different aspects of the computing environment or the data it is processing, among other reasons. Network devices 102 may interact with the computing environment 114 through a number of ways, such as, for example, over one or more networks 108.

In some examples, network devices 102 may provide a large amount of data, either all at once or streaming over a period of time (e.g., using event stream processing (ESP)), to the computing environment 114 via networks 108. For example, the network devices can transmit electronic messages for use in implementing any feature or combination of features described in the present disclosure, all at once or streaming over a period of time, to the computing environment 114 via networks 108.

The network devices 102 may include network computers, sensors, databases, or other devices that may transmit or otherwise provide data to computing environment 114. For example, network devices 102 may include local area network devices, such as routers, hubs, switches, or other computer networking devices. These devices may provide a variety of stored or generated data, such as network data or data specific to the network devices 102 themselves. Network devices 102 may also include sensors that monitor their environment or other devices to collect data regarding that environment or those devices, and such network devices 102 may provide data they collect over time. Network devices 102 may also include devices within the internet of things, such as devices within a home automation network. Some of these devices may be referred to as edge devices, and may involve edge-computing circuitry. Data may be transmitted by network devices 102 directly to computing environment 114 or to network-attached data stores, such as network-attached data stores 110 for storage so that the data may be retrieved later by the computing environment 114 or other portions of data transmission network 100. For example, the network devices 102 can transmit data for implementing any feature or combination of features described in the present disclosure to a network-attached data store 110 for storage. The computing environment 114 may later retrieve the data from the network-attached data store 110 and use the data to construct, for example, a training data set, multi-layered GUI, or both.

Network-attached data stores 110 can store data to be processed by the computing environment 114 as well as any intermediate or final data generated by the computing system in non-volatile memory. But in certain examples, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated dynamically (e.g., on the fly). In this situation, the computing environment 114 may be configured to retain the processed information within memory so that responses can be generated for the user at different levels of detail as well as allow a user to interactively query against this information.

Network-attached data stores 110 may store a variety of different types of data organized in a variety of different ways and from a variety of different sources. For example, network-attached data stores may include storage other than primary storage located within computing environment 114 that is directly accessible by processors located therein. Network-attached data stores may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory medium in which data can be stored and that does not include carrier waves or transitory electronic communications. Examples of a non-transitory medium may include, for example, a magnetic disk or tape, optical storage media such as compact disk or digital versatile disk, flash memory, memory or memory devices. A computer-program product may include code or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data, such as data from a website (e.g., a forum post, a Twitter™ tweet, a Facebook™ post, a blog post, an online review), a text message, an e-mail, or any combination of these.

The unstructured data may be presented to the computing environment 114 in different forms such as a flat file or a conglomerate of data records, and may have data values and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time-stamped data may be aggregated by time (e.g., into daily time period units) to generate time series data or structured hierarchically according to one or more dimensions (e.g., parameters, attributes, or variables). For example, data may be stored in a hierarchical data structure, such as a relational online analytical processing (ROLAP) or multidimensional online analytical processing (MOLAP) database, or may be stored in another tabular form, such as in a flat-hierarchy form.

Data transmission network 100 may also include one or more server farms 106. Computing environment 114 may route select communications or data to the sever farms 106 or one or more servers within the server farms 106. Server farms 106 can be configured to provide information in a predetermined manner. For example, server farms 106 may access data to transmit in response to a communication. Server farms 106 may be separately housed from each other device within data transmission network 100, such as computing environment 114, or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more websites, sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time. As another example, website data may be analyzed to determine one or more sentiments expressed in comments, posts, or other data provided by users.

Data transmission network 100 may also include one or more cloud networks 116. Cloud network 116 may include a cloud infrastructure system that provides cloud services. In certain examples, services provided by the cloud network 116 may include a host of services that are made available to users of the cloud infrastructure system on demand. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network 116 can dynamically scale to meet the needs of its users. The cloud network 116 may include one or more computers, servers, or systems. In some examples, the computers, servers, or systems that make up the cloud network 116 are different from the user's own on-premises computers, servers, or systems. For example, the cloud network 116 may host an application, and a user may, via a communication network such as the Internet, order and use the application on demand. In some examples, the cloud network 116 may host an application for performing data analytics or sentiment analysis on data. Additionally or alternatively, the cloud network 116 may host an application for implementing any feature or combination of features described in the present disclosure.

While each device, server, and system in FIG. 1 is shown as a single device, multiple devices may instead be used. For example, a set of network devices can be used to transmit various communications from a single user, or remote server 140 may include a server stack. As another example, data may be processed as part of computing environment 114.

Each communication within data transmission network 100 (e.g., between client devices, between a device and connection management system 150, between server farms 106 and computing environment 114, or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a Bluetooth or a Bluetooth Low Energy channel. A wired network may include a wired interface. The wired or wireless networks may be implemented using routers, access points, bridges, gateways, or the like, to connect devices in the network 108. The networks 108 can be incorporated entirely within or can include an intranet, an extranet, or a combination thereof. In one example, communications between two or more systems or devices can be achieved by a secure communications protocol, such as secure sockets layer (SSL) or transport layer security (TLS). In addition, data or transactional details may be encrypted.

Some aspects may utilize the Internet of Things (IoT), where things (e.g., machines, devices, phones, sensors) can be connected to networks and the data from these things can be collected and processed within the things or external to the things. For example, the IoT can include sensors in many different devices, and high value analytics can be applied to identify hidden relationships and drive increased efficiencies. This can apply to both big data analytics and real-time (e.g., ESP) analytics.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The computing nodes in the communications grid 120 and the transmission network database system 118 may share the same processor hardware, such as processors that are located within computing environment 114.

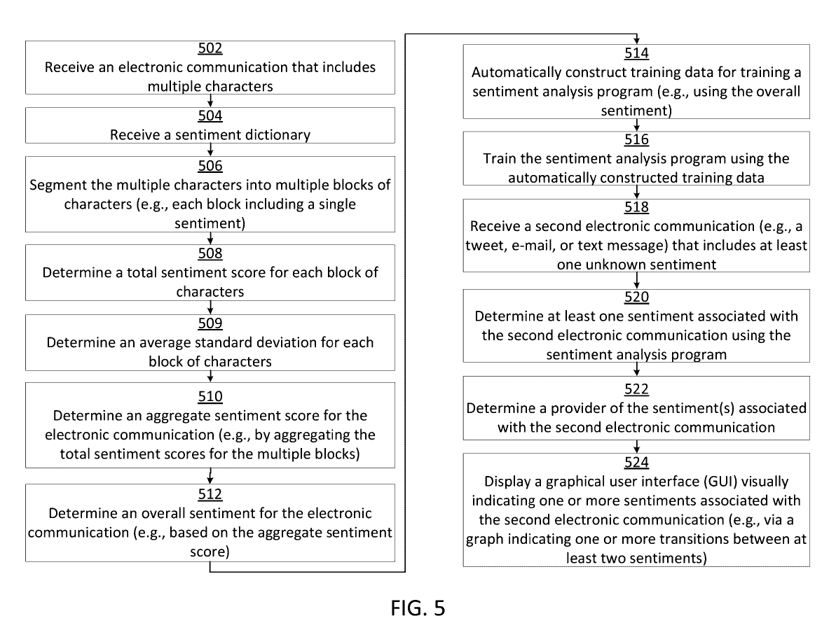

In some examples, the computing environment 114, a network device 102, or both can perform one or more processes for implementing any feature or combination of features described in the present disclosure. For example, the computing environment 114, a network device 102, or both can implement one or more of the processes discussed with respect to FIGS. 5-6, 9-10, and 12-17.

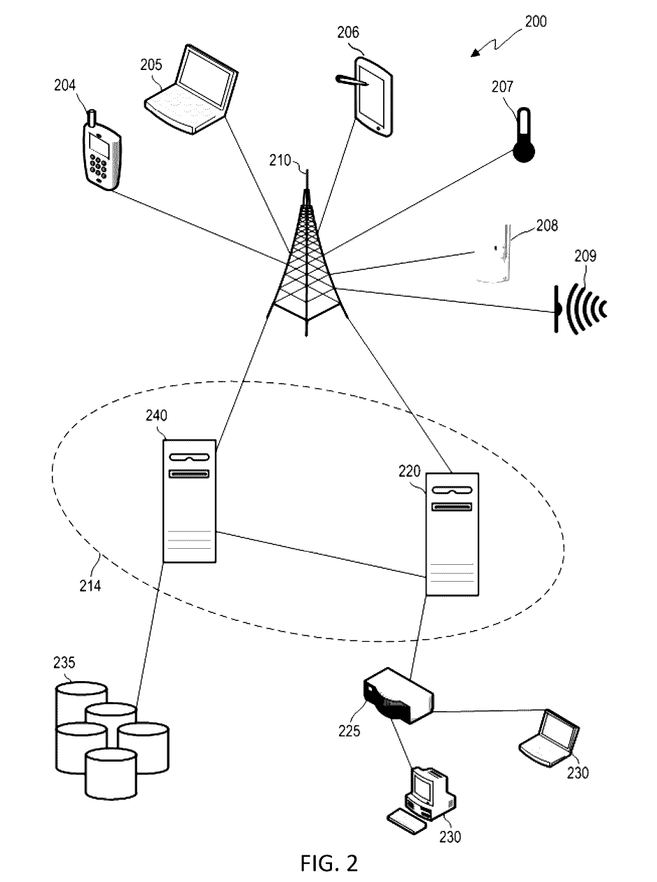

FIG. 2 is an example of devices that can communicate with each other over an exchange system and via a network according to some aspects. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). In some examples, the communication can include a narrative with one or more sentiments. The communication can be routed to another network device, such as network devices 205-209, via base station 210. The communication can also be routed to computing environment 214 via base station 210. In some examples, the network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor, respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, and electrical current, among others. The sensors may be mounted to various components used as part of a variety of different types of systems. The network devices may detect and record data related to the environment that it monitors, and transmit that data to computing environment 214.

The network devices 204-209 may also perform processing on data it collects before transmitting the data to the computing environment 214, or before deciding whether to transmit data to the computing environment 214. For example, network devices 204-209 may determine whether data collected meets certain rules, for example by comparing data or values calculated from the data and comparing that data to one or more thresholds. The network devices 204-209 may use this data or comparisons to determine if the data is to be transmitted to the computing environment 214 for further use or processing. In some examples, the network devices 204-209 can pre-process the data prior to transmitting the data to the computing environment 214. For example, the network devices 204-209 can reformat the data before transmitting the data to the computing environment 214 for further processing (e.g., which can include one or more steps for providing visualizations for electronic narrative analytics).

Computing environment 214 may include machines 220, 240. Although computing environment 214 is shown in FIG. 2 as having two machines 220, 240, computing environment 214 may have only one machine or may have more than two machines. The machines 220, 240 that make up computing environment 214 may include specialized computers, servers, or other machines that are configured to individually or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with client devices 230 via one or more routers 225. Computing environment 214 may collect, analyze or store data from or pertaining to communications, client device operations, client rules, or user-associated actions stored at one or more data stores 235. Such data may influence communication routing to the devices within computing environment 214, how data is stored or processed within computing environment 214, among other actions.

Notably, various other devices can further be used to influence communication routing or processing between devices within computing environment 214 and with devices outside of computing environment 214. For example, as shown in FIG. 2, computing environment 214 may include a machine 240 that is a web server. Computing environment 214 can retrieve data of interest, such as client information (e.g., product information, client rules, etc.), technical product details, news, blog posts, e-mails, forum posts, electronic documents, social media posts (e.g., Twitter™ posts or Facebook™ posts), and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices 204-209 may receive data periodically and in real time from a web server or other source. Devices within computing environment 214 may also perform pre-analysis on data it receives to determine if the data received should be processed as part of an ongoing project. For example, as part of a project in which narrative data is analyzed, the computing environment 214 can perform a pre-analysis of the data. The pre-analysis can include determining whether the narrative data has previously been analyzed. Additionally or alternatively, the pre-analysis can include determining whether the data is in a correct format for narrative analysis and, if not, reformatting the data into the correct format.

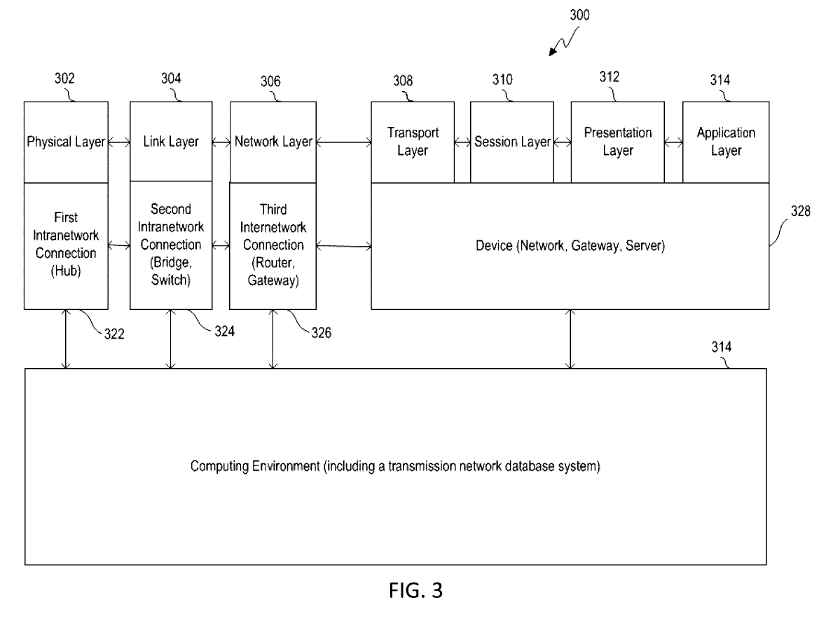

FIG. 3 is a block diagram of a model of an example of a communications protocol system according to some aspects. More specifically, FIG. 3 identifies operation of a computing environment in an Open Systems Interaction model that corresponds to various connection components. The model 300 shows, for example, how a computing environment, such as computing environment (or computing environment 214 in FIG. 2) may communicate with other devices in its network, and control how communications between the computing environment and other devices are executed and under what conditions.

The model 300 can include layers 302-314. The layers 302-314 are arranged in a stack. Each layer in the stack serves the layer one level higher than it (except for the application layer, which is the highest layer), and is served by the layer one level below it (except for the physical layer 302, which is the lowest layer). The physical layer 302 is the lowest layer because it receives and transmits raw bites of data, and is the farthest layer from the user in a communications system. On the other hand, the application layer is the highest layer because it interacts directly with a software application.

As noted, the model 300 includes a physical layer 302. Physical layer 302 represents physical communication, and can define parameters of that physical communication. For example, such physical communication may come in the form of electrical, optical, or electromagnetic communications. Physical layer 302 also defines protocols that may control communications within a data transmission network.

Link layer 304 defines links and mechanisms used to transmit (e.g., move) data across a network. The link layer manages node-to-node communications, such as within a grid-computing environment. Link layer 304 can detect and correct errors (e.g., transmission errors in the physical layer 302). Link layer 304 can also include a media access control (MAC) layer and logical link control (LLC) layer.

Network layer 306 can define the protocol for routing within a network. In other words, the network layer coordinates transferring data across nodes in a same network (e.g., such as a grid-computing environment). Network layer 306 can also define the processes used to structure local addressing within the network.

Transport layer 308 can manage the transmission of data and the quality of the transmission or receipt of that data. Transport layer 308 can provide a protocol for transferring data, such as, for example, a Transmission Control Protocol (TCP). Transport layer 308 can assemble and disassemble data frames for transmission. The transport layer can also detect transmission errors occurring in the layers below it.

Session layer 310 can establish, maintain, and manage communication connections between devices on a network. In other words, the session layer controls the dialogues or nature of communications between network devices on the network. The session layer may also establish checkpointing, adjournment, termination, and restart procedures.

Presentation layer 312 can provide translation for communications between the application and network layers. In other words, this layer may encrypt, decrypt or format data based on data types known to be accepted by an application or network layer.

Application layer 314 interacts directly with software applications and end users, and manages communications between them. Application layer 314 can identify destinations, local resource states or availability or communication content or formatting using the applications.

For example, a communication link can be established between two devices on a network. One device can transmit an analog or digital representation of an electronic message that includes at least one sentiment to the other device. The other device can receive the analog or digital representation at the physical layer 302. The other device can transmit the data associated with the electronic message through the remaining layers 304-314. The application layer 314 can receive data associated with the electronic message. The application layer 314 can identify one or more applications, such as a narrative analysis application, to which to transmit data associated with the electronic message. The application layer 314 can transmit the data to the identified application.

Intra-network connection components 322, 324 can operate in lower levels, such as physical layer 302 and link layer 304, respectively. For example, a hub can operate in the physical layer, a switch can operate in the physical layer, and a router can operate in the network layer. Inter-network connection components 326, 328 are shown to operate on higher levels, such as layers 306-314. For example, routers can operate in the network layer and network devices can operate in the transport, session, presentation, and application layers.

A computing environment 330 can interact with or operate on, in various examples, one, more, all or any of the various layers. For example, computing environment 330 can interact with a hub (e.g., via the link layer) to adjust which devices the hub communicates with. The physical layer 302 may be served by the link layer 304, so it may implement such data from the link layer 304. For example, the computing environment 330 may control which devices from which it can receive data. For example, if the computing environment 330 knows that a certain network device has turned off, broken, or otherwise become unavailable or unreliable, the computing environment 330 may instruct the hub to prevent any data from being transmitted to the computing environment 330 from that network device. Such a process may be beneficial to avoid receiving data that is inaccurate or that has been influenced by an uncontrolled environment. As another example, computing environment 330 can communicate with a bridge, switch, router or gateway and influence which device within the system (e.g., system 200) the component selects as a destination. In some examples, computing environment 330 can interact with various layers by exchanging communications with equipment operating on a particular layer by routing or modifying existing communications. In another example, such as in a grid-computing environment, a node may determine how data within the environment should be routed (e.g., which node should receive certain data) based on certain parameters or information provided by other layers within the model.

The computing environment 330 may be a part of a communications grid environment, the communications of which may be implemented as shown in the protocol of FIG. 3. For example, referring back to FIG. 2, one or more of machines 220 and 240 may be part of a communications grid-computing environment. A gridded computing environment may be employed in a distributed system with non-interactive workloads where data resides in memory on the machines, or compute nodes. In such an environment, analytic code, instead of a database management system, can control the processing performed by the nodes. Data is co-located by pre-distributing it to the grid nodes, and the analytic code on each node loads the local data into memory. Each node may be assigned a particular task, such as a portion of a processing project, or to organize or control other nodes within the grid. For example, each node may be assigned a portion of a processing task for implementing any feature or combination of features described in the present disclosure.

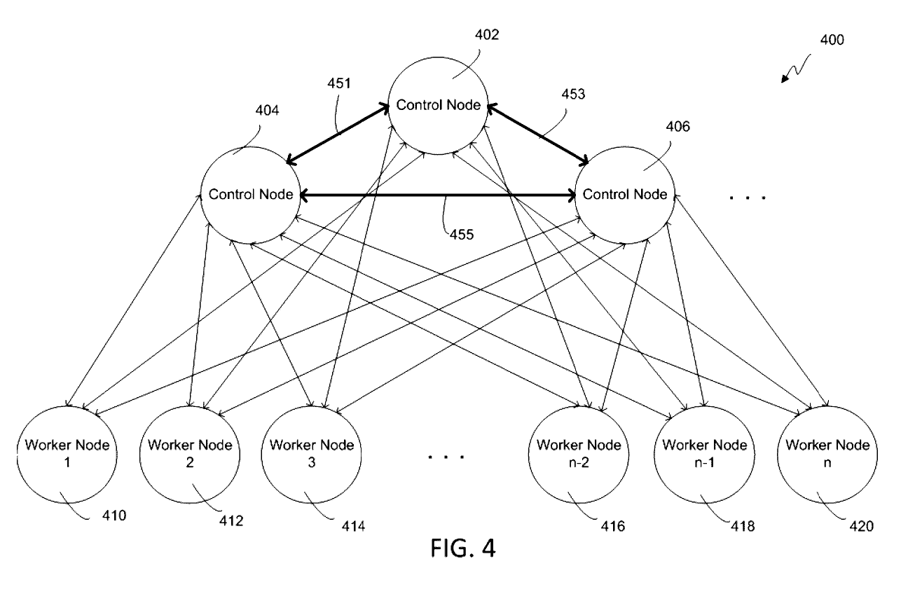

FIG. 4 is a hierarchical diagram of an example of a communications grid computing system 400 including a variety of control and worker nodes according to some aspects. Communications grid computing system 400 includes three control nodes and one or more worker nodes. Communications grid computing system 400 includes control nodes 402, 404, and 406. The control nodes are communicatively connected via communication paths 451, 453, and 455. The control nodes 402-406 may transmit information (e.g., related to the communications grid or notifications) to and receive information from each other. Although communications grid computing system 400 is shown in FIG. 4 as including three control nodes, the communications grid may include more or less than three control nodes.

Communications grid computing system 400 (which can be referred to as a “communications grid”) also includes one or more worker nodes. Shown in FIG. 4 are six worker nodes 410-420. Although FIG. 4 shows six worker nodes, a communications grid can include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid computing system 400 may be connected (wired or wirelessly, and directly or indirectly) to control nodes 402-406. Each worker node may receive information from the control nodes (e.g., an instruction to perform work on a project) and may transmit information to the control nodes (e.g., a result from work performed on a project). Furthermore, worker nodes may communicate with each other directly or indirectly. For example, worker nodes may transmit data between each other related to a narrative analysis job being performed or an individual task within a narrative analysis job being performed by that worker node. In some examples, worker nodes may not be connected (communicatively or otherwise) to certain other worker nodes. For example, a worker node 410 may only be able to communicate with a particular control node 402. The worker node 410 may be unable to communicate with other worker nodes 412-420 in the communications grid, even if the other worker nodes 412-420 are controlled by the same control node 402.

A control node 402-406 may connect with an external device with which the control node 402-406 may communicate (e.g., a communications grid user, such as a server or computer, may connect to a controller of the grid). For example, a server or computer may connect to control nodes 402-406 and may transmit a project or job to the node, such as a narrative analysis project. The project may include a data set. The data set may be of any size. Once the control node 402-406 receives such a project including a large data set, the control node may distribute the data set or projects related to the data set to be performed by worker nodes. Alternatively, for a project including a large data set, the data set may be receive or stored by a machine other than a control node 402-406 (e.g., a Hadoop data node).

Control nodes 402-406 can maintain knowledge of the status of the nodes in the grid (e.g., grid status information), accept work requests from clients, subdivide the work across worker nodes, and coordinate the worker nodes, among other responsibilities. Worker nodes 412-420 may accept work requests from a control node 402-406 and provide the control node with results of the work performed by the worker node. A grid may be started from a single node (e.g., a machine, computer, server, etc.). This first node may be assigned or may start as the primary control node 402 that will control any additional nodes that enter the grid.

When a project is submitted for execution (e.g., by a client or a controller of the grid) it may be assigned to a set of nodes. After the nodes are assigned to a project, a data structure (e.g., a communicator) may be created. The communicator may be used by the project for information to be shared between the project code running on each node. A communication handle may be created on each node. A handle, for example, is a reference to the communicator that is valid within a single process on a single node, and the handle may be used when requesting communications between nodes.

A control node, such as control node 402, may be designated as the primary control node. A server, computer or other external device may connect to the primary control node. Once the control node 402 receives a project, the primary control node may distribute portions of the project to its worker nodes for execution. For example, a project for providing visualizations for electronic narrative analytics can be initiated on communications grid computing system 400. A primary control node can control the work to be performed for the project in order to complete the project as requested or instructed. The primary control node may distribute work to the worker nodes 412-420 based on various factors, such as which subsets or portions of projects may be completed most efficiently and in the correct amount of time. For example, a worker node 412 may analyze a portion of data that is already local (e.g., stored on) the worker node. The primary control node also coordinates and processes the results of the work performed by each worker node 412-420 after each worker node 412-420 executes and completes its job. For example, the primary control node may receive a result from one or more worker nodes 412-420, and the primary control node may organize (e.g., collect and assemble) the results received and compile them to produce a complete result for the project received from the end user.

Any remaining control nodes, such as control nodes 404, 406, may be assigned as backup control nodes for the project. In an example, backup control nodes may not control any portion of the project. Instead, backup control nodes may serve as a backup for the primary control node and take over as primary control node if the primary control node were to fail. If a communications grid were to include only a single control node 402, and the control node 402 were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes 402-406, including a backup control node, may be beneficial.

In some examples, the primary control node may open a pair of listening sockets to add another node or machine to the grid. A socket may be used to accept work requests from clients, and the second socket may be used to accept connections from other grid nodes. The primary control node may be provided with a list of other nodes (e.g., other machines, computers, servers, etc.) that can participate in the grid, and the role that each node can fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it can check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. But, a hierarchy of nodes may also be determined using methods other than using the unique identifiers of the nodes. For example, the hierarchy may be predetermined, or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404, 406 (and, for example, to other control or worker nodes 412-420 within the communications grid). Such communications may be sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes 410-420 in the communications grid, unique identifiers of the worker nodes 410-420, or their relationships with the primary control node 402) and the status of a project (including, for example, the status of each worker node's portion of the project). The snapshot may also include analysis or results received from worker nodes 410-420 in the communications grid. The backup control nodes 404, 406 may receive and store the backup data received from the primary control node 402. The backup control nodes 404, 406 may transmit a request for such a snapshot (or other information) from the primary control node 402, or the primary control node 402 may send such information periodically to the backup control nodes 404, 406.

As noted, the backup data may allow a backup control node 404, 406 to take over as primary control node if the primary control node 402 fails without requiring the communications grid to start the project over from scratch. If the primary control node 402 fails, the backup control node 404, 406 that will take over as primary control node may retrieve the most recent version of the snapshot received from the primary control node 402 and use the snapshot to continue the project from the stage of the project indicated by the backup data. This may prevent failure of the project as a whole.

A backup control node 404, 406 may use various methods to determine that the primary control node 402 has failed. In one example of such a method, the primary control node 402 may transmit (e.g., periodically) a communication to the backup control node 404, 406 that indicates that the primary control node 402 is working and has not failed, such as a heartbeat communication. The backup control node 404, 406 may determine that the primary control node 402 has failed if the backup control node has not received a heartbeat communication for a certain predetermined period of time. Alternatively, a backup control node 404, 406 may also receive a communication from the primary control node 402 itself (before it failed) or from a worker node 410-420 that the primary control node 402 has failed, for example because the primary control node 402 has failed to communicate with the worker node 410-420.

Different methods may be performed to determine which backup control node of a set of backup control nodes (e.g., backup control nodes 404, 406) can take over for failed primary control node 402 and become the new primary control node. For example, the new primary control node may be selected based on a ranking or “hierarchy” of backup control nodes based on their unique identifiers. In an alternative example, a backup control node may be assigned to be the new primary control node by another device in the communications grid or from an external device (e.g., a system infrastructure or an end user, such as a server or computer, controlling the communications grid). In another alternative example, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative example, the primary control node may transmit a communication to each of the operable worker nodes still on the communications grid that each of the worker nodes should purposefully fail also. After each of the worker nodes fail, they may each retrieve their most recent saved checkpoint of their status and re-start the project from that checkpoint to minimize lost progress on the project being executed. In some examples, a communications grid computing system 400 can be used to implement any feature or combination of features described in the present disclosure.

FIG. 5 is a flow chart of an example of a process for automatically constructing training sets for electronic sentiment analysis according to some aspects. Some examples can be implemented using any of the systems and configurations described with respect to FIGS. 1-4.

In block 502, a processor receives an electronic communication that includes multiple characters. Examples of the electronic communication can include a text message, an e-mail, an electronic document, a social media post (e.g., a Twitter™ tweet, a Facebook™ post, etc.), a blog post, a forum post, a chat log, or any combination of these. For example, the processor can receive a chat log that includes a discussion between two users about a company or product. The electronic communication can be in any language, such as English, French, German, Spanish, etc.

The processor can receive the electronic communication from a remote electronic device, such as a remote computing device or server. For example, the processor can access a remote database and submit one or more queries (e.g., SQL queries) to obtain desired data. The remote database can respond by transmitting the electronic communication to the processor. The electronic communication can include the desired data.

In some examples, the processor may reformat, clean, or otherwise pre-process at least a portion of the data from the electronic communication. For example, if the electronic communication includes webpage data, the processor can extract the text of the webpage from the programming data (e.g., HyperText Markup Language, JavaScript, or Cascading Style Sheet data). As another example, the processor can aggregate data or electronic communications from various sources into a single data set or electronic communication for later use.

In some examples, the electronic communication can be used for training a sentiment analysis program, which can be provided in the form of computer program code or other executable instructions. For example, at least a portion of the data from the electronic communication can be used for automatically constructing a training set for training a classification system associated with the sentiment analysis program. The classification system can include one or more neural networks, one or more classifiers (such as a Naïve Bayes classifier or a support vector machine), or both.

In block 504, the processor can receive a sentiment dictionary. The processor can receive the sentiment dictionary from a remote electronic device, such as a remote computing device or server. For example, the processor can download the sentiment dictionary from a remote server.

The sentiment dictionary can include a database in which expressions (e.g., words) are mapped to corresponding sentiment values. A sentiment value can be a numerical value representative of a sentiment (e.g., an opinion, feeling, emotion, or attitude) associated with a particular expression. In some examples, the sentiment value can be a number between 1 and 9. For example, the expression “hate” can be mapped to a sentiment value of 7.8 in the sentiment dictionary. In some examples, separate sentiment dictionaries can be used for different languages. For example, one sentiment dictionary can be used for English expressions, another sentiment dictionary can be used for Spanish expressions, still another sentiment dictionary can be used for French expressions, etc.

In some examples, the sentiment dictionary can map an expression to two or more values. For example, the sentiment dictionary can map an expression to a pleasure value. The pleasure value can represent a level to which the expression is used to convey a pleasant or an unpleasant sentiment. The pleasure value can be a number between 1 and 9. The sentiment dictionary can additionally or alternatively map the expression to an activation value. The activation value can represent a level to which the expression is used to convey an aroused sentiment or a sedated sentiment. The sentiment dictionary can additionally or alternatively map the expression to a dominance value. The dominance value can represent a level to which a particular expression influences the sentiment of a text block including the expression. By mapping an expression to two or more values, more data can be associated with each expression.

In block 506, the processor can segment the multiple characters into multiple blocks of characters (e.g., segments). The processor can segment or divide the multiple characters into the blocks of characters based on one or more criteria. For example, the processor can segment the multiple characters into blocks of characters such that each block of characters includes a single sentiment, a single topic, a single sentence, or any combination of these.

As discussed above, the processor can divide the multiple characters into the blocks such that each block includes a single sentence. For example, the processor can search the multiple characters for punctuation marks and divide the multiple characters into blocks based on the locations of the punctuation marks. In one such example, the processor can segment “I looked out my window. It was a beautiful day.” into two blocks of characters, one block of characters including “I looked out my window” and another block of characters including “It was a beautiful day.” In some examples, by dividing the electronic communication into blocks of characters in which each block of characters includes a single sentence, it may increase the likelihood that each block of characters includes only a single sentiment (e.g., a positive, negative, or neutral sentiment). For example, it may be more likely that single sentence includes a single uniform sentiment than multiple sentences. It can be desirable to have each block of characters include only a single sentiment, as this can reducing the likelihood of multiple different sentiments within a single block of characters canceling each other out. Reducing the likelihood of multiple different sentiments canceling each other out can improve the accuracy of the system. Thus, in some examples, each block of characters can include a single sentence indicating or expressing a single sentiment.

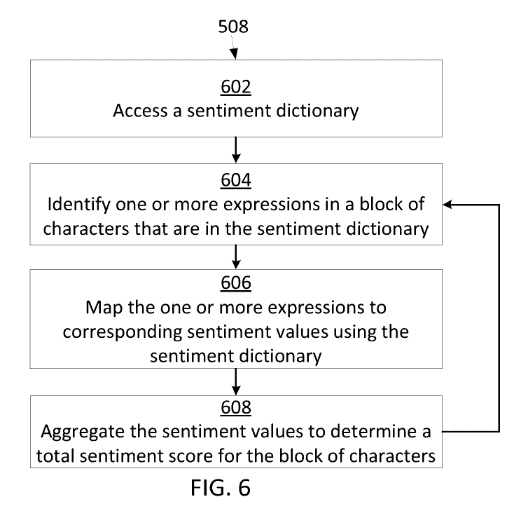

In block 508, the processor can determine a total sentiment score for each block of characters. In some examples, the processor can determine the total sentiment score for each block of characters according to the process shown in FIG. 6.

Referring to FIG. 6, in block 602, the processor can access a sentiment dictionary (e.g., the sentiment dictionary received in block 504 of FIG. 5). In some examples, the sentiment dictionary can be stored locally in a local memory device. The processor can retrieve the sentiment dictionary from the local memory device. In other examples, the sentiment dictionary can be stored remotely and accessible via a network, such as over the Internet. The processor can transmit one or more queries or other communications to one or more remote devices to access the sentiment dictionary.

In block 604, the processor can identify one or more expressions in a block of characters that are in the sentiment dictionary. For example, the processor can identify one or more words within a block of characters (e.g., generated in block 506 of FIG. 5) that are within the sentiment dictionary. In one example, the processor can analyze a block of characters including the sentence “This is absolutely terrible news” for expressions that are in the sentiment dictionary. The processor can determine that the expressions “absolutely” and “terrible” are within the sentiment dictionary.

In block 606, the processor can map the one or more expressions to corresponding sentiment values using the sentiment dictionary. For example, the processor can map the expression “absolutely” to a corresponding sentiment value of 6.3. The processor can additionally or alternatively map the expression “terrible” to a corresponding sentiment value of 1.9.

In some examples, the processor can map one or more sentiment values to a corresponding standard deviation using the sentiment dictionary. For example, the sentiment dictionary can include an expression mapped to a corresponding sentiment value and standard deviation. The standard deviation can represent the agreement (or disagreement) among a group of human evaluators as to the “correct” sentiment value for the particular expression. For example, to build the sentiment dictionary, each participant in a group of human evaluators may assign a sentiment value to an expression in the sentiment dictionary. But the inherent subjectivity of such a method may cause the assigned sentiment values to vary. In some examples, a standard deviation of the assigned sentiment values can be calculated and included in the sentiment dictionary. A higher standard deviation associated with a particular expression can indicate a higher amount of disagreement between the human evaluators as to the “correct” sentiment value for the expression, and a lower standard deviation associated with a particular expression can indicate a lower amount of disagreement between the human evaluators as to the “correct” sentiment value for the expression.

In block 608, the processor can aggregate (e.g., statistically aggregate, average, or otherwise combine) the sentiment values to determine a total sentiment score for the block of characters. For example, the processor can average the sentiment value of 6.3 for the expression “absolutely” and the sentiment value 1.9 for the expression “terrible” to determine the total sentiment score of 4.1.

In some examples, the processor can aggregate weighted sentiment values to determine the total score for the block of characters. The processor can weight each sentiment value based on a standard deviation corresponding to the sentiment value. For example, the processor can multiply sentiment values associated with lower standard deviations by larger weighting factors. The processor can multiply sentiment values associated with higher standard deviations by smaller weighting factors. The processor can aggregate the weighted sentiment values to determine the total sentiment score for the block of characters.

In examples in which the sentiment dictionary includes a pleasure value, an arousal value, or both, the processor can determine multiple total scores for the block of characters. For example, the processor can aggregate the pleasure values for the one or more expressions to determine a total pleasure score. The processor can additionally or alternatively aggregate the arousal values for the one or more expressions to determine a total arousal value. The processor can determine the total sentiment score based on the total pleasure value, the total arousal value, or both. For example, the processor can use the total pleasure value or the total arousal value as the total sentiment score.

Returning to FIG. 5, in block 509, the processor determines an average standard deviation for each block of characters. For example, the processor can access the sentiment dictionary and determine a standard deviation corresponding to each sentiment value associated with a particular block of characters. The processor can determine an average of the standard deviations. This can be the average standard deviation for the block of characters.

In block 510, the processor determines an aggregate sentiment score for the electronic communication. The processor can determine the aggregate sentiment score by aggregating the total sentiment scores for the blocks of characters.

In some examples, the processor can aggregate weighted total sentiment scores to determine the aggregate sentiment score. For example, the processor can multiply a larger weighting factor by a total sentiment score corresponding to a block of characters associated with a lower average standard deviation. The processor can multiply a smaller weighting factor by a total sentiment score corresponding to a block of characters associated with a larger average standard deviation. The processor can aggregate the weighted total sentiment scores to determine the aggregate sentiment score for the electronic communication.

For example, if one block of characters is associated with a total sentiment score of 3.7 and an average standard deviation of 2.5, the processor can multiply the total sentiment score by a weighting factor of 0.76. If another block of characters is associated with a total sentiment score of 4.2 and a standard deviation of 7.5, the processor can multiply the total sentiment score by a weighting factor of 0.24. The processor can aggregate the weighted total sentiment scores to determine an aggregate sentiment score of 3.8.

In block 512, the processor determines an overall sentiment for the electronic communication (e.g., based on the aggregate sentiment score). The overall sentiment can include positive, negative, or neutral. For example, the processor can determine whether the aggregate sentiment score falls within a range of sentiment scores. If so, the processor can determine that the overall sentiment for the electronic communication is neutral. If the processor determines that the aggregate sentiment score exceeds the range of sentiment scores, the processor can determine that the overall sentiment for the electronic communication is positive. If the processor determines that the aggregate sentiment score is below the range of sentiment scores, the processor can determine that the overall sentiment for the electronic communication is negative.

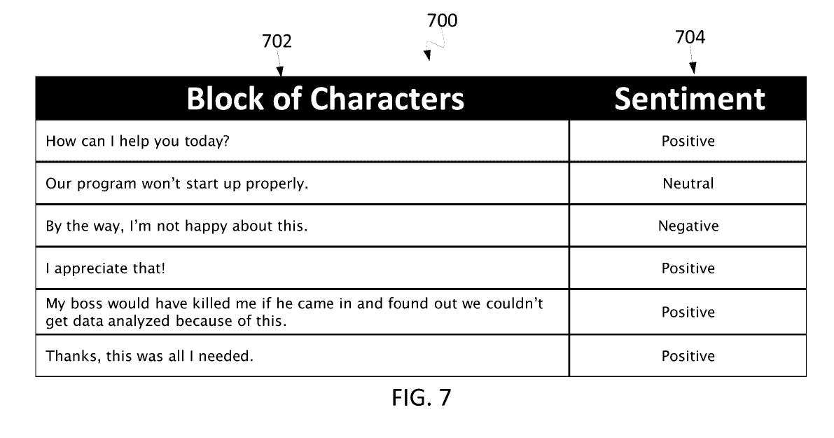

In some examples, the processor can determine an overall sentiment for one or more blocks of characters of the electronic communication. The processor can determine the overall sentiment for a block of characters based on an associated total sentiment score. For example, the processor can determine whether the total sentiment score for the block of characters falls within a range of sentiment scores. If so, the processor can determine that the overall sentiment for the block of characters is neutral. If the processor determines that the total sentiment score for the block of characters exceeds the range of sentiment scores, the processor can determine that the overall sentiment for the block of characters is positive. If the processor determines that the total sentiment score for the block of characters is below the range of sentiment scores, the processor can determine that the overall sentiment for the block of characters is negative. For instance, FIG. 7 is a table 700 showing an example of blocks of characters and their corresponding overall sentiments. The table 700 can include two or more columns 702, 704. One column 702 can include a block of characters. Each block of characters can represent an individual sentence, such as a sentence segmented from a chat communication between two participants (e.g., a user of a product and a representative of a company). One or more expressions within each block of characters can be mapped to sentiment values in a sentiment dictionary. The sentiment values can be used to determine a total sentiment score for the block of characters. The total sentiment score can indicate an overall sentiment for the block of characters as positive, neutral, or negative. The corresponding overall sentiment for each block of characters is shown in column 704.

In block 514 of FIG. 5, the processor automatically constructs training data (e.g., a training set) for training a sentiment analysis program. The processor can automatically construct the training data using, at least in part, a total sentiment score for a block of characters, an overall sentiment for a block of characters, the aggregate sentiment score for the electronic communication, the overall sentiment for the electronic communication, or any combination of these. For example, the processor can include a total sentiment score, an aggregate sentiment score, or an overall sentiment associated with the electronic communication in a database or data set used for training a classification system associated with the sentiment analysis program.

In some examples, the processor can perform the operations of blocks 502-512 on multiple electronic communications. The processor can automatically construct the training data using, at least in part, a total sentiment score, an aggregate sentiment score, an overall sentiment, or any combination of these associated with each electronic communication. For example, the processor can include a total sentiment score, an aggregate sentiment score, or an overall sentiment associated with each electronic communication in a database or data set. The database or data set can be used for training the sentiment analysis program.

In block 516, the processor trains the sentiment analysis program using the automatically constructed training data. For example, the sentiment analysis program can include a classification system that can be trained using the training data. The classification system can include one or more computer-implemented algorithms or models, such as neural networks or classifiers, that can be tuned, trained, or otherwise configured using the training data.

For example, the classification system can include one or more neural networks. Neural networks can be represented as one or more layers of interconnected “neurons” that can exchange data between one another. The connections between the neurons can have numeric weights that can be tuned based on experience. Such tuning can make neural networks adaptive and capable of “learning.” Tuning the numeric weights can increase the accuracy of output provided by the neural network. The numeric weights can be tuned through training. In some examples, the processor can train a neural network of the classification system using the training data automatically constructed in block 514. The processor can provide the training data to the neural network, and the neural network can use the training data to tune one or more numeric weights of the neural network.

The classification system can be trained using backpropagation. In examples in which the classification system includes a neural network, backpropagation can include determining a gradient of a particular numeric weight based on a difference between an actual output of the neural network and a desired output of the neural network. Based on the gradient, one or more numeric weights of the neural network can be updated to reduce the difference, thereby increasing the accuracy of the neural network. In some examples, this process can be repeated multiple times to train the neural network.

In block 518, the processor receives a second electronic communication (e.g., a social media post, a chat log, a news article, etc.). The second electronic communication can include at least one unknown sentiment. It may be desirable to determine one or more sentiments associated with the second electronic communication. In some examples, the processor can perform sentiment analysis on the second electronic communication using the sentiment analysis program to determine one or more sentiments associated with the second electronic communication.

In block 520, the processor determines at least one sentiment associated with the second electronic communication using the sentiment analysis program. In some examples, the sentiment analysis program can be a standalone program or included in another analysis program or tool, such as SAS Text Analytics™ (from SAS Institute, Inc.™ of Cary, N.C., USA). The processor can execute the sentiment analysis program using the second electronic communication as an input for the sentiment analysis program. The sentiment analysis program can determine (e.g., using one or more neural networks, classifiers, or both) at least one sentiment associated with the second electronic communication.

In some examples, the processor can segment the second electronic communication into multiple blocks of characters. The processor can segment the second electronic communication using any of the methods discussed above (e.g., in block 506). For example, the processor can segment the second electronic communication into block of characters, where each block of characters can include a single sentence, a single unknown sentiment, a single topic, or any combination of these. The processor can, using the sentiment analysis program, analyze a block of characters to determine a corresponding sentiment expressed in the block of characters. The processor can repeat this process for all the blocks of characters, thereby determining multiple sentiments associated with the second electronic communication. This can provide a more granular level of sentiment analysis than, for example, determining a single sentiment associated with the entire second electronic communication as a whole.

In block 522, the processor determines a provider of the sentiment(s) associated with the second electronic communication. For example, the processor can analyze data (e.g., metadata) associated with the second electronic communication to determine a particular person, entity, user, and/or other provider associated with a particular sentiment (e.g., as determined in block 520) expressed in the second electronic communication.

For example, the second electronic communication can include a chat session between two or more participants. The processor can determine sentiments associated with different lines in the chat session. The processor can also analyze data associated with the chat session to determine which participant is associated with each of the determined sentiments. The processor can store associations between the determined sentiments and the corresponding providers in memory. The processor can determine any number of providers for any number of sentiments.

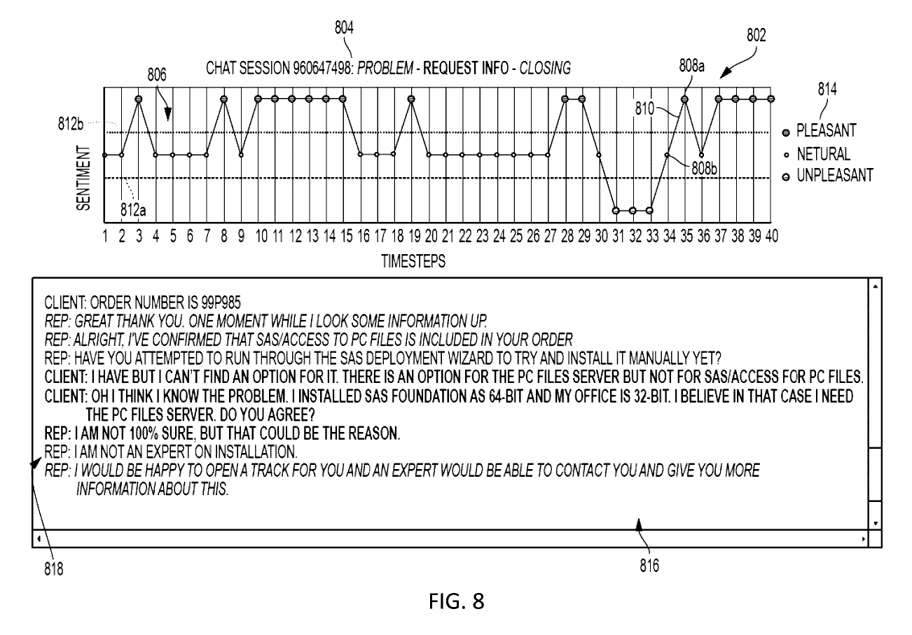

In block 524, the processor can cause a display device (e.g., a computer monitor, television, touch-screen display, liquid crystal display, etc.) to display a graphical user interface (GUI). The GUI can visually indicate one or more sentiments associated with the second electronic communication. In some examples, the GUI can visually indicate the one or more sentiments via a graph, such as a line graph. For example, FIG. 8 is an example of a GUI 802 showing multiple sentiments associated with a chat session between two users (e.g., the entirety of which can make up the second electronic communication) according to some aspects. The two users can include a customer of a company and a representative of the company. The GUI 802 can include a graph 806 visually indicating one or more sentiments associated with one or more portions of the chat session. For example, each point on the graph 806 can correspond to a line or sentence of the chat session and represent a positive sentiment, a negative sentiment, or a neutral sentiment.

The graph 806 can include a timeline along the X-axis and a sentiment value along the Y-axis. As shown in FIG. 8, the timeline can include segment numbers (e.g., the first segment can be at time 1, the second segment can be at time 2, etc.). In other examples, the time along the X-axis can include a time that the segment was created. For example, the time along the X-axis can include timestamps indicating when each sentence in the chat session was typed. This can provide a user with information, such as how long each sentence took to type during the chat session or the duration of delays between responses by participants in the chat.

In some examples, each point on the graph can include a shape. The shape can be a circle, square, rectangle, triangle, or other shape. In some examples, the shape can indicate a source of a corresponding segment. For example, a triangle-shaped point can indicate that a corresponding sentence of the chat session was typed by the customer. A circle-shaped point can indicate that a corresponding sentence of the chat session was typed by the representative of the company. In some examples, a color of the shape can represent a particular sentiment associated with the shape (e.g., as designated by a legend 814).

The GUI 802 can visually indicate at least one transition between at least two sentiments. For example, the graph 806 can visually indicate a transition 810 between point 808b and point 808a. This transition 810 can visually represent a transition between a neutral sentiment (e.g., as indicated by point 808b) and a positive sentiment (e.g., as indicated by point 808a). The graph 806 can allow the user to visually determine a flow of sentiments associated with the chat session over time and identify locations in this chat session where the sentiment changes, where the sentiment varies rapidly, where the sentiment remains constant, or any combination of these.

In some examples, the GUI 802 can include a lower boundary 812a, an upper boundary 812b, or both indicating a range of values. In one example, points above the range of values, such as point 808a, can represent a pleasant or positive sentiment. Points within the range, such as 808b, can represent a neutral sentiment. Points below the range of values can represent an unpleasant or negative sentiment.

In some examples, the GUI 802 can include at least a portion of the chat session transcript 818. The portion of the chat session transcript 818 can be positioned in a scrollable window or frame 816. In some examples, each line in the chat session transcript 818 can be color coded or otherwise visually indicate whether the line is associated with a positive sentiment, a negative sentiment, or a neutral sentiment (e.g., via italicized, regular, or bold font, respectively). This can allow the user to visually determine a sentiment associated with a particular portion of the chat session transcript quickly. The GUI 802 can additionally or alternatively include other information 804, such as a customer number, a chat session number, a problem characterization, a status, etc.

In some examples, GUI 802 can combine multiple sources and types of information into a single visualization that is easy to understand for users. For example, a sentiment can be represented by a color and/or position of a point 808a on a graph 806, and a provider of the sentiment (e.g. a customer or representative in a chat) can be represented by a shape of the point 808a (e.g. circle, square, triangle, and so on). This may allow a user to see both the sentiment and the segment's provider in a single visualization. This can reduce the need for extensive training for users to understand and explore the sentiment analysis results.

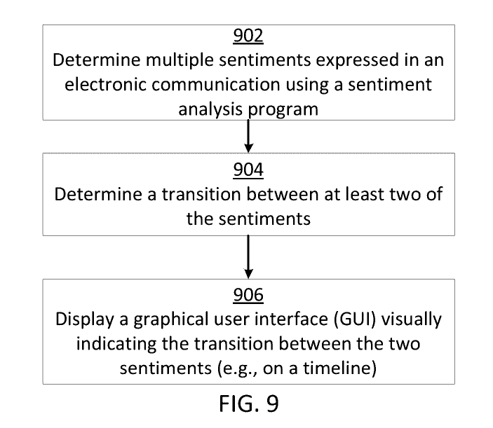

FIG. 9 is a flow chart of an example of a process for generating a GUI according to some aspects. In block 902 of FIG. 9, the processor can determine multiple sentiments expressed in an electronic communication using a sentiment analysis program. For example, the processor can receive an electronic communication including a chat transcript from a chat session. The processor can divide the chat transcript into multiple segments (e.g., with each segment including a single sentence or line in the chat transcript). The processor can execute the sentiment analysis program using the segments as inputs and determine a sentiment associated with each segment. The sentiment can be a positive sentiment, a neutral sentiment, or a negative sentiment.

In block 904, the processor can determine a transition between at least two of the sentiments. The transition can indicate a change between the two different sentiments occurring over a period of time. For example, the processor can determine the transition between a positive sentiment and a negative sentiment occurring over a period of time within the chat session.

In block 906, the processor can cause a display device to display a GUI that visually indicates the transition between the at least two sentiments. The processor can visually indicate the transition on a timeline including a timeframe associated with multiple segments of the electronic communication.

For example, the processor can cause the display device to output a GUI that includes a graph. The graph can include a timeline along the X-axis. The graph can include a sentiment value, such as a pleasure value or arousal value, along the Y-axis. One point on the graph can indicate one sentiment. Another point on the graph can indicate another sentiment. A line connecting the points can visually indicate the transition between the sentiments.

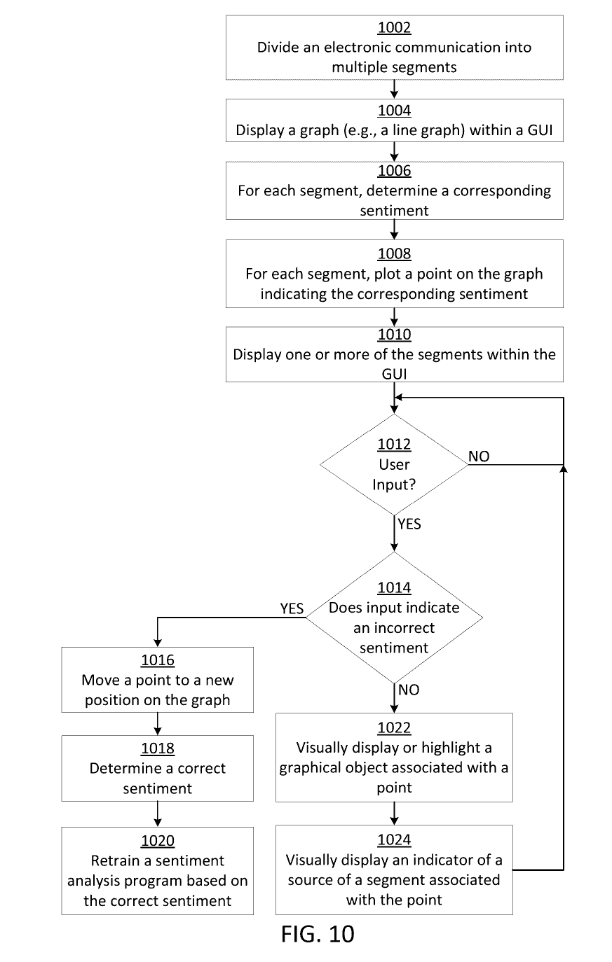

FIG. 10 is a flow chart of an example of another process for generating a GUI according to some aspects. In some examples, the operations of the process shown in FIG. 10 can be used in combination with one or more operations shown in FIG. 9.

In block 1002, the processor divides an electronic communication into multiple segments. For example, the processor can receive an electronic communication that includes a chat transcript from a chat session. The chat transcript can include multiple sentences or comments. The processor can divide the chat transcript into multiple segments, such that each segment includes a single sentence or comment from the chat transcript.

In block 1004, the processor causes a display device to display a graph within the GUI. For example, the processor can cause the display device to output a line graph within the GUI.

In block 1006, the processor determines a sentiment corresponding to each segment. For example, the processor can perform sentiment analysis on a segment to determine a corresponding sentiment. The processor can repeat this process for all the segments. The processor can perform the sentiment analysis using a sentiment analysis program (e.g., stored in memory).

In block 1008, the processor causes a point to be plotted on the graph indicating the corresponding sentiment for each segment. For example, the processor can position a point on the graph in a location indicative of the corresponding sentiment for a particular segment. In some examples, the processor can position each point on the graph above a reference line if the sentiment is positive, on the reference line if the sentiment is neutral, or below the reference line if the sentiment is negative. The processor can repeat this process for all of the sentiments. Thus, the graph can visually represent the various sentiments associated with the various segments from the electronic communication. For example, the graph can visually represent the various sentiments associated with different comments from a chat session.

In block 1010, the processor causes the display device to display one or more of the segments within the GUI. For example, referring to FIG. 8, the processor can cause the GUI to output the chat session transcript 818 in the GUI 802.

In block 1012, the processor determines if a user input was received. For example, the processor can be coupled to an input device, such as a touch-screen display, a touchpad, a keyboard, a mouse, a joystick, or a button. The processor can receive and analyze communications from the input device to determine if a user provided input. In some examples, the user input can include selecting or clicking on a particular point on the graph, hovering a cursor over a particular point on the graph, or dragging a point on the graph from one position to another position on the graph. If the processor determines that a user input was received, the process can continue to block 1014. Otherwise, the process can return to block 1012.

In block 1014, the processor determines if the user input indicates an incorrect sentiment. In some examples, the user can provide input via one or more GUI controls (e.g., by manipulating an input field, a virtual button, a virtual slider, or a virtual switch) indicating that a point on the graph corresponds to an incorrect sentiment. For example, the user can drag a point from one location to a new location on the graph. This may indicate that the point was originally in a position corresponding to an incorrect sentiment, and the new position may correspond to a correct sentiment. If the processor determines that the user input indicates an incorrect sentiment, the process can continue to block 1016. Otherwise, the process can continue to block 1022.

In block 1016, the processor moves a point to a new position on the graph. For example, if the user input includes dragging a point from one location to a new location on the graph, the processor can update the graph to show the point in the new location.

In block 1018, the processor determines a correct sentiment. For example, the processor can determine a correct sentiment based on the new position of the point on the graph. In some examples, the user can provide the correct sentiment via one or more GUI controls. For example, the user can manipulate one or more GUI controls via an input device, such as a touch-screen display, to input the correct sentiment. In response, the input device can transmit a communication associated with the correct sentiment to the processor. The processor can receive the communication and determine the correct sentiment based on the communication.

In block 1020, the processor retrains the sentiment analysis program (e.g., the classification system of the sentiment analysis program) based on the correct sentiment. For example, the processor can update the training data based on the correct sentiment. The processor can then retrain one or more neural networks, classifiers, or any combination of these associated with the sentiment analysis program using the updated training data.

In some examples, the combination of blocks 1018-1020 can provide a feedback loop in which a user can identify and correct erroneous sentiments. For example, the user can identify a point on the graph that corresponds to an incorrect sentiment. The point can indicate that a corresponding segment of the electronic communication expresses one sentiment (e.g., a positive sentiment) when the corresponding segment actually expresses another sentiment (e.g., a negative sentiment or a neutral sentiment). The user can drag the point to a new location on the graph indicating a correct sentiment. In some examples, the processor can update the training data based on the correct sentiment. The processor can then retrain the sentiment analysis program using the updated training data, which can increase the accuracy of the sentiment analysis program. This feedback loop can leverage user insights to improve the accuracy of the sentiment analysis program.

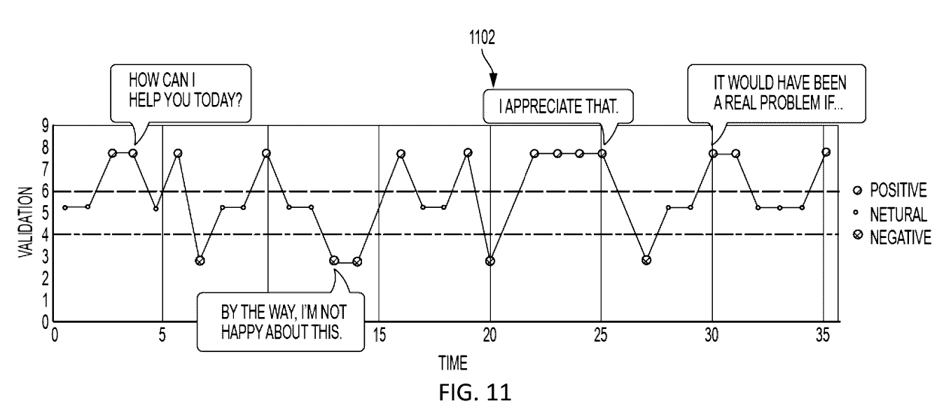

In block 1022, the processor causes the GUI to visually display or visually highlight a graphical object associated with a point on the graph. In some examples, the graphical object can include a bubble. For example, referring to FIG. 11, the graphical object can include bubble 1102. The bubble 1102 can be positioned adjacent to the point. In some examples, the bubble 1102 can include a comment or a portion of the electronic communication corresponding to the point on the graph.

In some examples, the processor can cause the GUI to visually display or visually highlight the graphical object in response to determining that the user input includes selecting the point, clicking the point, hovering over the point (e.g., with a mouse cursor), or any combination of these. For example, the processor can cause the GUI to display the bubble 1102 in response to determining that the user input includes clicking the point. As another example, the processor can cause the GUI to highlight a segment of the electronic communication corresponding to the point and output within the GUI in response to determining that the user input includes hovering over the point. For example, referring to FIG. 8, the processor can cause the GUI to visually highlight a portion of the chat session transcript 818 corresponding to the point in response to determining that the user input includes hovering over the point. Such interactive features can provide a more immersive, comprehensive, and productive user experience.

In block 1024 of FIG. 10, the processor can cause the GUI to visually display an indicator of a source of a segment associated with the point. The indicator can include a graphical object (e.g., bubble 1102 of FIG. 11), a color, a shape, a shading, or any combination of these. In some examples, the source can include a particular user, for example, a particular user that engaged in a chat session. For example, the processor can cause the GUI to display a graphical object indicating a particular user that typed a particular message (in a chat session) corresponding to the point. As another example, the processor can cause the point to have a particular shape, shading, or color indicating that a particular user typed the message corresponding to the point. The indicator can be included within, or separate from, the graphical object displayed in block 1022.

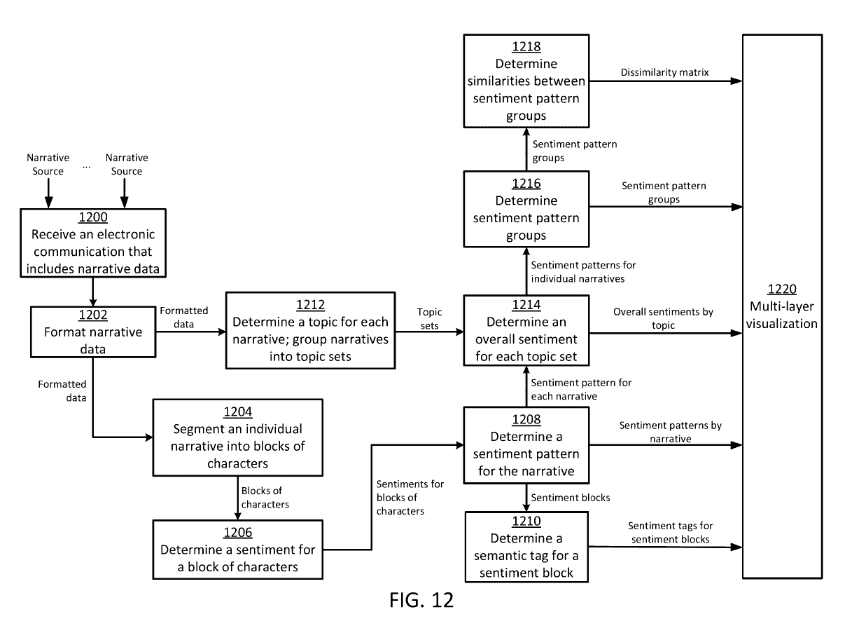

FIG. 12 is a flow chart of an example of a process for providing visualizations for electronic narrative analytics according to some aspects. Some examples can be implemented using any of the systems, configurations, and processes described with respect to FIGS. 1-11.

In block 1200, a processor receives an electronic communication that includes narrative data associated with one or more narratives. Examples of the electronic communication can include a text message, an e-mail, an electronic document, a social media post (e.g., a Twitter™ tweet, a Facebook™ post, etc.), a blog post, a forum post, a chat log, or any combination of these. An example of narrative data can include a chat log of a discussion between two users about a company or product. The narrative data can be in any language or combination of languages, such as English, French, German, Spanish, etc.

The processor can receive the electronic communication from a narrative source. The narrative source can include a remote electronic device, such as a remote computing device or server. For example, the processor can transmit one or more queries (e.g., SQL queries) to a remote database to obtain narrative data. The remote database can respond by transmitting the electronic communication to the processor. The electronic communication can include the narrative data.

In block 1202, the processor can format the narrative data from the electronic communication. Formatting the narrative data can include reformatting (e.g., to a new or different format), cleaning, adding data to (e.g., attaching metadata), removing data from, or otherwise pre-processing at least a portion of the narrative data from the electronic communication. For example, if the narrative data includes webpage data, the processor can extract the text of the webpage from the programming data of the webpage (e.g., HyperText Markup Language, JavaScript, or Cascading Style Sheet data) and use the text of the webpage as the narrative data. As another example, the processor can aggregate narrative data from various narrative sources into a single data set for later use. As still another example, if narratives of a particular type typically include similar or identical text in certain portions, the processor may strip the text from the narrative. This may reduce or eliminate the influence of this standard text on the results. For example, a chat log between a customer representative of a company and a customer may generally include the same introductory text (e.g., the customer representative asking about the customer's problem) and ending text (e.g., the customer representative wishing the customer well). In such an example, the processor may remove the introductory and ending text.

In block 1204, the processor can segment (or divide) narrative data for an individual narrative into blocks of characters. In examples in which the electronic communication includes narrative data for multiple different narratives, the processor can segment the narrative data for each individual narrative into respective blocks of characters.

The processor can segment the narrative data into the blocks of characters based on one or more criteria. For example, the processor can segment the narrative data into blocks of characters such that each block of characters includes a single sentiment, a single topic, a single sentence, or any combination of these. In some examples, the processor can divide the narrative data into blocks of characters that each includes a single sentence by searching the narrative data for punctuation marks and dividing the narrative data into blocks of characters based on the locations of the punctuation marks. In one such example, the processor can segment the phrase, “I looked out my window. It was a beautiful day.” into two blocks of characters with one block of characters including “I looked out my window” and another block of characters including “It was a beautiful day”. Dividing the narrative data into blocks of characters that each includes a single sentence may increase the likelihood that each block of characters expresses only a single sentiment (e.g., a positive, negative, or neutral sentiment). For example, it may be more likely that a single sentence expresses a single uniform sentiment than that multiple sentences express a single uniform sentiment. It can be desirable to have each block of characters express only a single sentiment, as this can reduce the likelihood of multiple different sentiments within a single block of characters canceling each other out. Reducing the likelihood of multiple different sentiments canceling each other out can improve the accuracy of the system. Thus, in some examples, each block of characters can include a single sentence indicating or expressing a single sentiment.

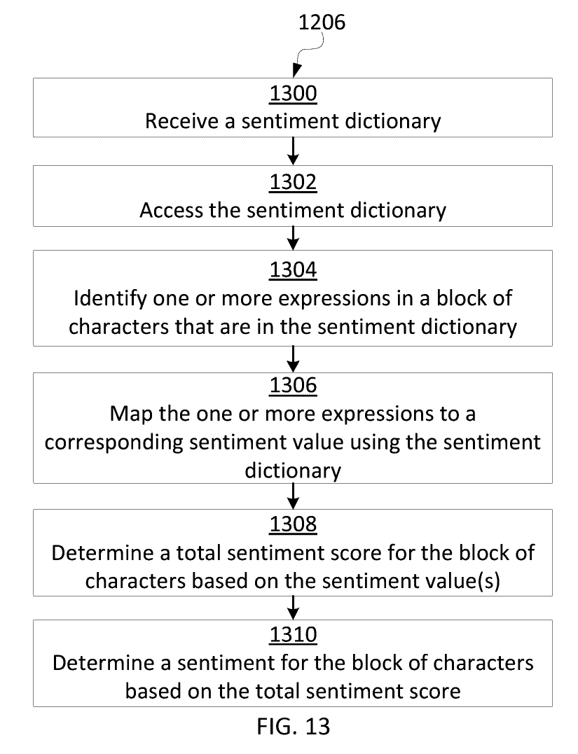

In block 1206, the processor can determine a sentiment for a block of characters. In examples in which a particular narrative (i.e., the narrative data associated with the narrative) has been segmented into multiple blocks of characters, the processor can determine a respective sentiment for each respective block of characters. In some examples, the processor can determine the sentiment(s) according to the process shown in FIG. 13.

Referring now to FIG. 13, in block 1300, the processor can receive a sentiment dictionary. The processor can receive the sentiment dictionary from a remote electronic device, such as a remote computing device or server. For example, the processor can download the sentiment dictionary from a remote server.

The sentiment dictionary can include a database in which expressions (e.g., words) are mapped to corresponding sentiment values. A sentiment value can be a numerical value representative of a sentiment (e.g., an opinion, feeling, emotion, or attitude) associated with a particular expression. In some examples, the sentiment value can be a number between 1 and 9. For example, the expression “hate” can be mapped to a sentiment value of 2.1 in the sentiment dictionary. In some examples, separate sentiment dictionaries can be used for different languages. For example, one sentiment dictionary can be used for English expressions, another sentiment dictionary can be used for Spanish expressions, still another sentiment dictionary can be used for French expressions, etc.

In some examples, the sentiment dictionary can map an expression to two or more values. For example, the sentiment dictionary can map an expression to a pleasure value. The pleasure value can represent a level to which the expression is used to convey a pleasant or an unpleasant sentiment. The pleasure value can be a number between 1 and 9. The sentiment dictionary can additionally or alternatively map the expression to an activation value. The activation value can represent a level to which the expression is used to convey an aroused sentiment or a sedated sentiment. The sentiment dictionary can additionally or alternatively map the expression to a dominance value. The dominance value can represent a level to which a particular expression influences the sentiment of a text block including the expression. By mapping an expression to two or more values, more data can be associated with each expression.

In block 1302, the processor can access the sentiment dictionary. In some examples, the sentiment dictionary can be stored locally in a local memory device. The processor can retrieve the sentiment dictionary from the local memory device. In other examples, the sentiment dictionary can be stored remotely and accessed via a network, such as over the Internet. The processor can transmit one or more queries or other communications to one or more remote devices to access the sentiment dictionary.

In block 1304, the processor can identify one or more expressions in a block of characters that are also in the sentiment dictionary. For example, the processor can identify one or more words within a block of characters (e.g., generated in block 1204 of FIG. 12) that are also within the sentiment dictionary. In one example, the processor can analyze a block of characters including the sentence “This is absolutely terrible news” for expressions that are in the sentiment dictionary. The processor can determine that the expressions “absolutely” and “terrible” are within the sentiment dictionary.

In block 1306, the processor can map the one or more expressions to corresponding sentiment values using the sentiment dictionary. For example, the processor can map the expression “absolutely” to a corresponding sentiment value of 6.3. The processor can additionally or alternatively map the expression “terrible” to a corresponding sentiment value of 1.9.

In some examples, the processor can map one or more sentiment values to a corresponding standard deviation using the sentiment dictionary. For example, the sentiment dictionary can include an expression mapped to a corresponding sentiment value and standard deviation. The standard deviation can represent the agreement (or disagreement) among a group of human evaluators as to the “correct” sentiment value for the particular expression. For example, to build the sentiment dictionary, each participant in a group of human evaluators may assign a sentiment value to an expression in the sentiment dictionary. But the inherent subjectivity of such a method may cause the assigned sentiment values to vary. In some examples, a standard deviation of the assigned sentiment values can be calculated and included in the sentiment dictionary. A higher standard deviation associated with a particular expression can indicate a higher amount of disagreement between the human evaluators as to the “correct” sentiment value for the expression, and a lower standard deviation associated with a particular expression can indicate a lower amount of disagreement between the human evaluators as to the “correct” sentiment value for the expression.

In block 1308, the processor can determine a total sentiment score for the block of characters based on the sentiment value(s). The processor can aggregate (e.g., statistically aggregate, average, or otherwise combine) the sentiment values to determine the total sentiment score for the block of characters. For example, the processor can average the sentiment value of 6.3 for the expression “absolutely” and the sentiment value 1.9 for the expression “terrible” to determine the total sentiment score of 4.1.

In some examples, the processor can aggregate weighted sentiment values to determine the total sentiment score for the block of characters. The processor can weight each sentiment value based on a standard deviation corresponding to the sentiment value. For example, the processor can multiply sentiment values associated with lower standard deviations by larger weighting factors. The processor can multiply sentiment values associated with higher standard deviations by smaller weighting factors. The processor can aggregate the weighted sentiment values to determine the total sentiment score for the block of characters.

For example, if one block of characters is associated with a total sentiment score of 3.7 and an average standard deviation of 2.5, the processor can multiply the total sentiment score by a weighting factor of 0.76. If another block of characters is associated with a total sentiment score of 4.2 and a standard deviation of 7.5, the processor can multiply the total sentiment score by a weighting factor of 0.24. The processor can aggregate the weighted total sentiment scores to determine an aggregate sentiment score of 3.8.

In examples in which the sentiment dictionary includes a pleasure value, an arousal value, or both, the processor can determine multiple total scores for the block of characters. For example, the processor can aggregate the pleasure values for the one or more expressions to determine a total pleasure score. The processor can additionally or alternatively aggregate the arousal values for the one or more expressions to determine a total arousal value. The processor can determine the total sentiment score based on the total pleasure value, the total arousal value, or both. For example, the processor can use the total pleasure value or the total arousal value as the total sentiment score.

In block 1310, the processor determines a sentiment for the block of characters based on the total sentiment score. The processor can determine a particular sentiment for the block of characters using a lookup table, database, algorithm, or any combination of these. For example, the processor may use a lookup table to map a total sentiment score that is between 1 and 4 to a negative sentiment, a total sentiment score that is between 4 and 6 to a neutral sentiment, and a total sentiment score that is between 6 and 9 to a positive sentiment. Other examples can include more or fewer total-sentiment-score ranges associated with more or fewer sentiments, respectively. This can provide for a higher, or lower, level of granularity when determining the sentiment for the block of characters.

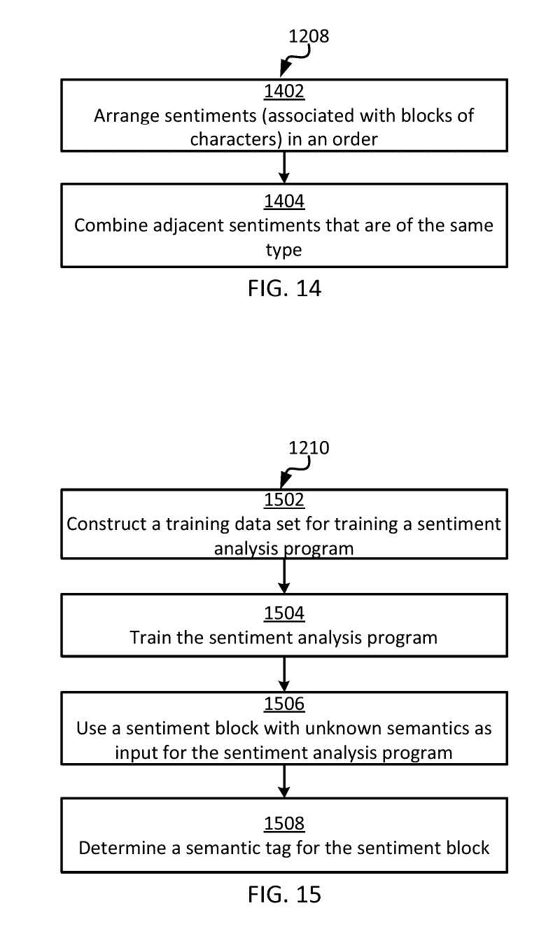

Returning to FIG. 12, in block 1208, the processor determines a sentiment pattern for the narrative. The sentiment pattern can be representative of multiple sentiments expressed within the narrative. In some examples, the processor can determine the sentiment pattern according to the steps shown in FIG. 14.

Referring now to FIG. 14, in block 1402, the processor can arrange the sentiments for each block of characters in an order. The order can be based on a position of the block of characters in the narrative. For example, if a first block of characters includes a first sentence in the narrative, the sentiment (e.g., a positive sentiment) corresponding to the first block of characters can be positioned first in the order. If a second block of characters includes a second sentence in the narrative, the sentiment (e.g., a negative sentiment) corresponding to the second block of characters can be positioned second in the order. If a third block of characters includes a third sentence in the narrative, the sentiment (e.g., a neutral sentiment) corresponding to the third block of characters can be positioned third in the order. In such an example, the sentiment pattern can be represented as “positive, negative, neutral.”

In block 1404, the processor can combine adjacent sentiments in the sentiment pattern that are of the same type. Combining adjacent sentiments in the sentiment pattern can reduce the total length of the sentiment pattern. This can significantly reduce the amount of computation time needed for subsequent operations and can simplify a visualization of the sentiment pattern.

For example, the processor can determine a sentiment pattern of “positive, positive, negative, neutral, neutral, neutral” for a narrative. The processor can combine adjacent sentiments of the same type, resulting in a compressed sentiment-pattern of “positive, negative, neutral.” In such an example, the “positive” in the sentiment pattern can represent a positive sentiment associated with two adjacent blocks of characters in the narrative. The “negative” in the sentiment pattern can represent a negative sentiment associated with a single block of characters in the narrative. The “neutral” in the sentiment pattern can represent a neutral sentiment associated with three adjacent blocks of characters in the narrative. The processor can use the compressed sentiment-pattern as the sentiment pattern for the narrative. In some examples, each value in the sentiment pattern (e.g., “positive” or “negative”) can be referred to as a “sentiment block.”

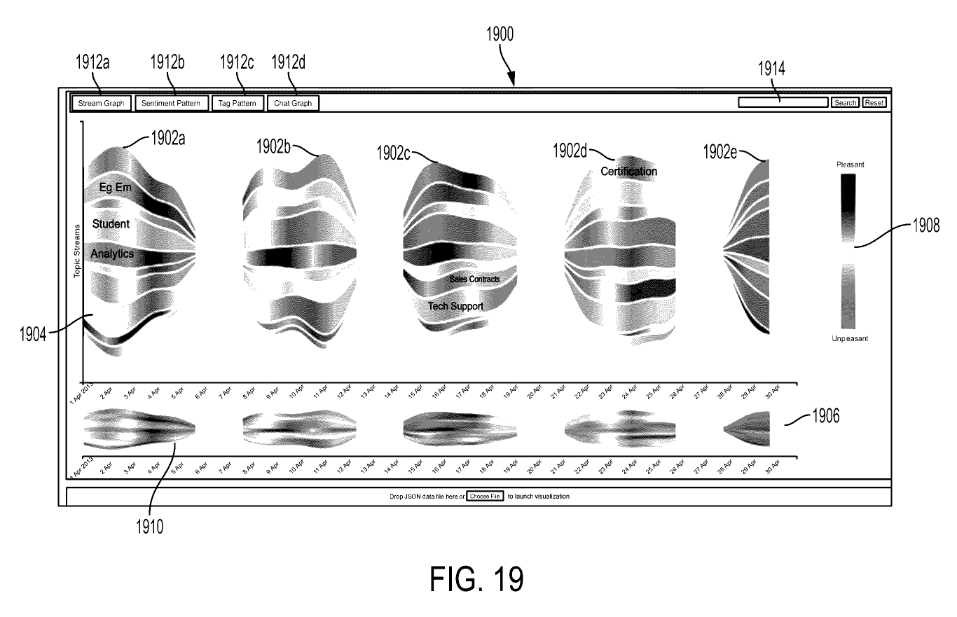

Returning to FIG. 12, in some examples, the sentiment patterns can be included within a multi-layer visualization 1220 (e.g., a multi-layer GUI). An example of the multi-layer visualization 1220 is discussed in greater detail with respect to FIGS. 19-24.

In block 1210, the processor determines a semantic tag for a sentiment block. For example, the processor can determine a corresponding semantic tag for each sentiment block of a sentiment pattern. The semantic tag can indicate (e.g., summarize) the content or text associated with the sentiment block. Examples of a semantic tag can include “question,” “new feature,” “greeting,” “help,” “confusion,” “request for information,” “solution,” etc. In some examples, the processor can determine the semantic tag according to the steps shown in FIG. 15.

Referring now to FIG. 15, in block 1502, the processor can construct (e.g., automatically construct) a training data set for training a sentiment analysis program. For example, the processor can receive user input indicating a sample set of narratives to use for training the sentiment analysis program. The processor can perform the steps of FIGS. 13-14 to determine sentiment blocks associated with each narrative of the sample set of narratives. The processor can then receive user input indicating a particular semantic tag to assign to a sentiment block based on the content associated with the sentiment block. For example, a sentiment pattern for a particular narrative may be “positive, negative, positive.” The first “positive” in the sentiment pattern can be associated with the two sentences “Today was a great day. The weather was nice.” The processor can receive user input indicating a particular semantic tag, such as “Weather,” to associate with the first “positive” of the sentiment pattern. The processor can store the association between the semantic tag and the sentiment block (e.g., the content associated with sentiment block) in a database. This process can be repeated for all of the sentiment blocks in the sample set of narratives, and the processor can use the resulting database as the training data set.

In block 1504, the processor can train the sentiment analysis program (e.g., using the training data set). In some examples, the processor can input the training data set into the sentiment analysis program for training the sentiment analysis program. Once trained, the sentiment analysis program may be able to estimate semantic tags for sentiment blocks with unknown semantics.

In block 1506, the processor can use one or more sentiment blocks that have unknown semantics (e.g., unknown meanings) as input to the sentiment analysis program. For example, the processor can transmit the content of a semantic block having unknown semantics to the sentiment analysis program for use as input to a neural network of the sentiment analysis program. The sentiment analysis program can receive the content and output a corresponding semantic tag. The processor can receive the semantic tag from the sentiment analysis program and associate the semantic tag with the sentiment block (or the content of the sentiment block) in a database.

In block 1508, the processor can determine a semantic tag for a sentiment block using the sentiment analysis program. In examples that include multiple sentiment blocks, the processor can determine a respective semantic tag for each sentiment block using the sentiment analysis program. The processor can determine the semantic tag, for example, using the method discussed above with respect to block 1506.

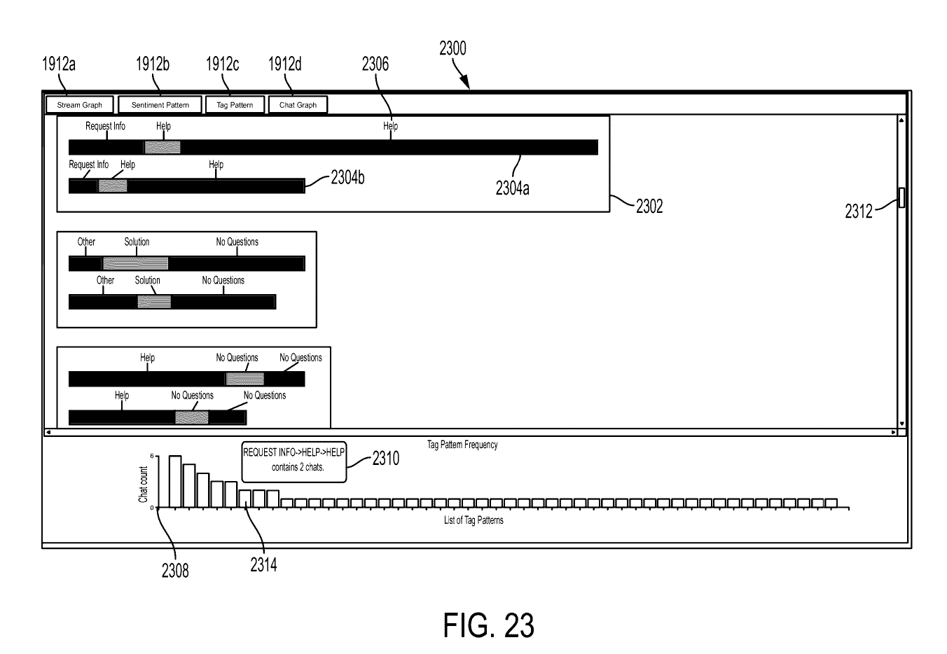

Returning to FIG. 12, in some examples, the semantic tags can be included within the multi-layer visualization 1220, as discussed in greater detail with respect to FIG. 23.

In block 1212, the processor can determine a respective topic for each narrative. The processor can execute a topic analysis program, such as SAS Text Miner™, for determining a topic associated with each respective narrative. For example, the processor can provide narrative data associated with a narrative as input to the topic analysis program, which can receive the narrative data and output an estimated topic associated with the narrative. Examples of topics may include “Registration,” “Guitars,” “Analytics,” a company name, a sports team, a hobby, etc.

The processor can group narratives with the same or similar topics into a topic set. For example, if one narrative has a topic of “Electric Guitars,” another narrative has a topic of “Acoustic Guitars,” and a third narrative has a topic of “Guitar Strings,” the processor may group all three narratives into a topic set called “Guitars” (or “Guitar Equipment” or “Instruments”).

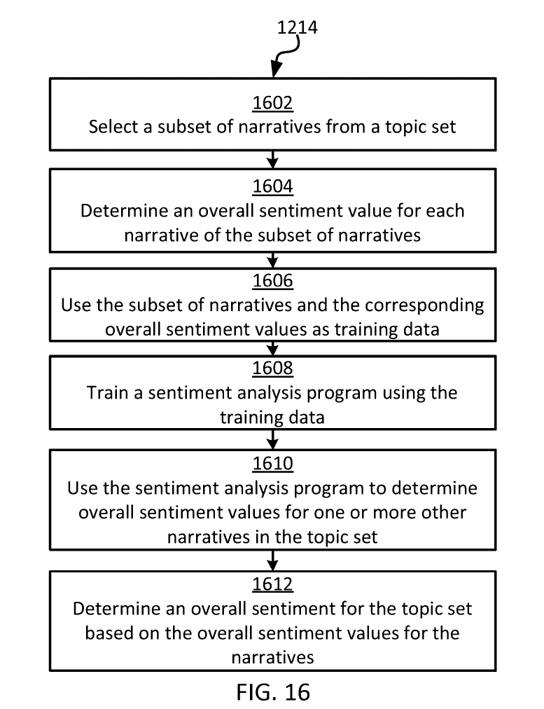

In block 1214, the processor determines an overall sentiment for each topic set. In some examples, the overall sentiment of a topic set can change over a period of time based on the narratives associated with the topic set. For example, the topic set can include a first narrative that occurred on a first date and has a positive sentiment. The topic set can include a second narrative that occurred on a second date (e.g., a later date) and has a negative sentiment. In such an example, the overall sentiment of the topic set can include a positive sentiment at the first date and change to a negative sentiment at the second date. Thus, the overall sentiment may not be a single sentiment value, but instead may include multiple sentiment values expressed over a period of time. In some examples, the processor can determine the overall sentiment for a topic set according to the steps shown in FIG. 16.

Referring now to FIG. 16, in block 1602, the processor can select a subset of narratives from a topic set. For example, if a topic set includes 15 narratives, the processor may select three of the narratives for use in the subset. The processor can randomly select narratives from the topic set for use in the subset of narratives or can select the narratives according to one or more algorithms.

In block 1604, the processor can determine an overall sentiment value for a narrative of the subset of narratives. For example, the processor can use any of the methods discussed above to segment a narrative into blocks of characters and determine a total sentiment score associated with each block of characters. The processor can then determine an aggregate sentiment score by adding the total sentiment scores for the blocks of characters. The processor can then determine the overall sentiment value for the narrative based on the aggregate sentiment score. The processor can repeat this process for each narrative of the subset of narratives.

In some examples, the processor can determine the aggregate sentiment score by aggregating weighted total-sentiment scores. For example, the processor can multiply a larger weighting factor by a total sentiment score corresponding to a block of characters associated with a lower average standard deviation. The processor can multiply a smaller weighting factor by a total sentiment score corresponding to a block of characters associated with a larger average standard deviation. The processor can aggregate the weighted total sentiment scores to determine the aggregate sentiment score for the narrative.

The processor can determine the overall sentiment value for the narrative based on the aggregate sentiment score. The overall sentiment value can include a numerical value (e.g., the aggregate sentiment score itself) or a particular sentiment, such as “positive,” “negative,” or “neutral.” For example, the processor can determine whether the aggregate sentiment score falls within a range of sentiment scores. If so, the processor can determine that the overall sentiment for the narrative is neutral. If the processor determines that the aggregate sentiment score exceeds the range of sentiment scores, the processor can determine that the overall sentiment for the narrative is positive. If the processor determines that the aggregate sentiment score is below the range of sentiment scores, the processor can determine that the overall sentiment for the narrative is negative.

In block 1606, the processor can use the subset of narratives and the corresponding overall sentiment values as training data for training a sentiment analysis program. In some examples, the processor can automatically construct the training data for training the sentiment analysis program using the subset of narratives and their corresponding overall sentiment values. For example, the processor can associate an overall sentiment value with a narrative (e.g., narrative data) in a database used for training a neural network of the sentiment analysis program.

In block 1608, the processor can train the sentiment analysis program using the training data. In some examples, the processor can train the sentiment analysis program using one or more of the methods discussed above, such as with respect to block 1504 of FIG. 15.

In block 1610, the processor can use the sentiment analysis program to determine overall sentiment values for one or more other narratives (e.g., narratives not in the training subset) in the topic set. For example, the processor can use the neural network to determine overall sentiment values for the remainder of the narratives in the topic set.

The other narratives in the topic set can include unknown sentiments. And it may be desirable to determine an overall sentiment value expressed by each narrative. The processor can use the sentiment analysis program to perform sentiment analysis on each respective narrative to determine a corresponding overall sentiment value.

In block 1612, the processor can determine an overall sentiment for the topic set based on the overall sentiment values of the narratives. As discussed above, the overall sentiment for the topic set can include multiple overall-sentiment-values expressed by multiple narratives over a period of time. The processor can determine the overall sentiment for the topic set by aggregating the overall sentiment values for at least two of the narratives in the topic set. For example, the processor can determine the overall sentiment for the topic set by aggregating all of the overall sentiment values for all of the narratives in the subset, including or excluding the narratives used in the training subset.

Returning to FIG. 12, in some examples, one or more overall sentiments for one or more topics can be included within the multi-layer visualization 1220, as discussed in greater detail with respect to FIG. 19.

In block 1216, the processor can determine sentiment pattern groups for the narratives in a topic set. For example, the processor can assign the narratives of a topic set to different sentiment-pattern groups based on the sentiment patterns of the narratives (e.g., as determined in block 1208), so that each sentiment pattern group includes narratives having a common sentiment-pattern. In one such example, a topic set can include 15 narratives. The processor can assign five of the narratives to one group because the narratives can all have the sentiment pattern “positive, negative, positive.” The processor can assign three of the narratives to another group because the narratives can all have the sentiment pattern “positive, negative, negative.” The processor can assign the remaining narratives to still another group because the narratives can all have the sentiment pattern “positive, negative, neutral.” The processor can assign the narratives of a topic set to any number of sentiment-pattern groups based on the number of different sentiment patterns expressed by the narratives.

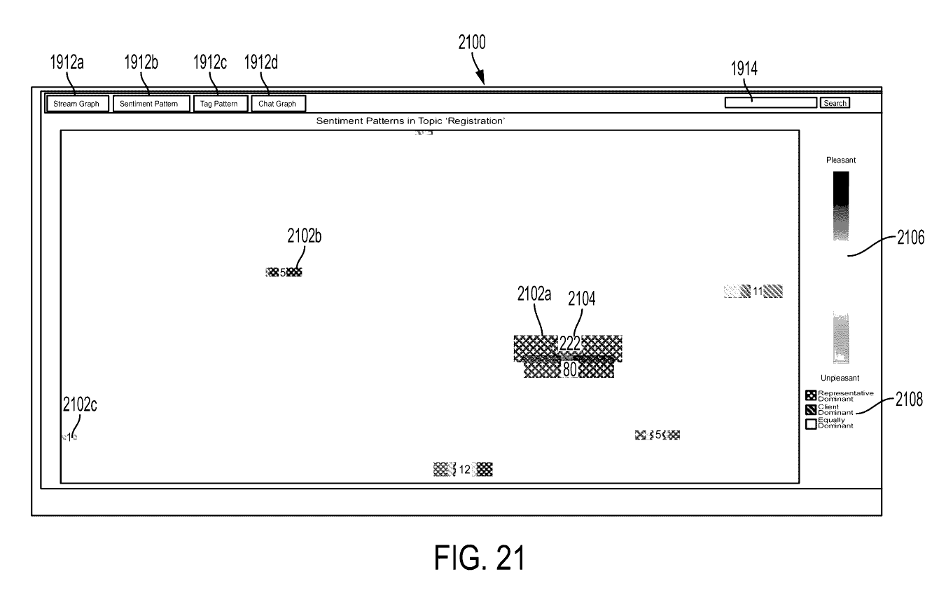

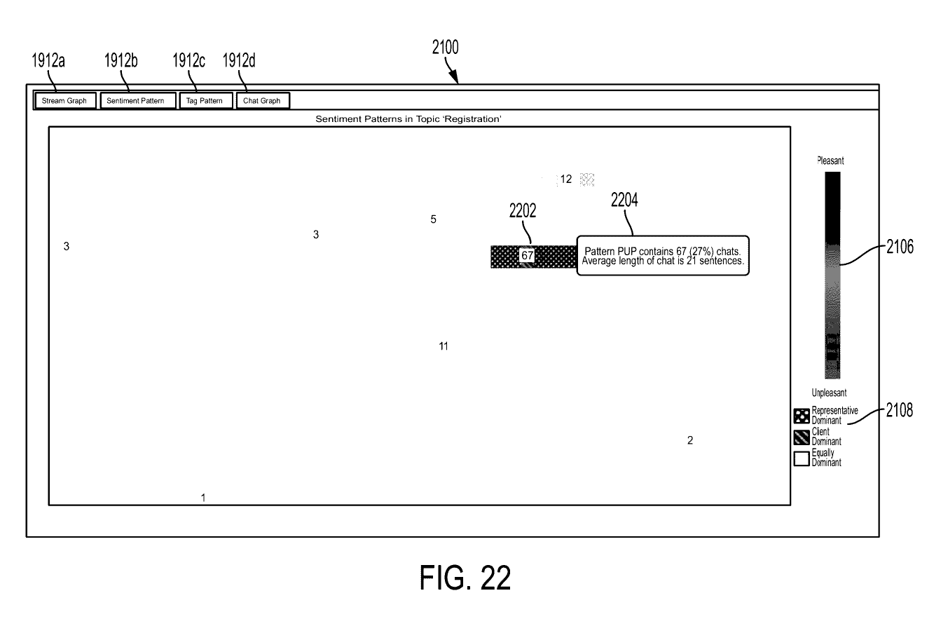

In some examples, one or more sentiment pattern groups for one or more topic sets can be included within the multi-layer visualization 1220, as discussed in greater detail with respect to FIGS. 21-22.

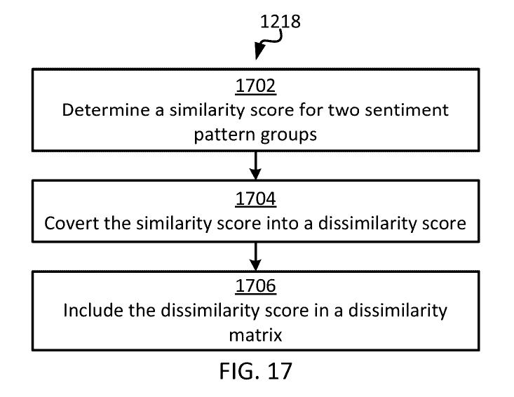

In block 1218, the processor can determine similarities (or differences) between the sentiment pattern groups. In some examples, the processor can determine the similarities (or dissimilarities) according to the steps shown in FIG. 17.

Referring now to FIG. 17, in block 1702, the processor can determine a similarity score for two sentiment-pattern groups. The similarity score can represent the similarity of the text of the narratives in the sentiment pattern groups. For example, the text of the narratives of one sentiment-pattern group can be compared to the text of the narratives of another sentiment-pattern group to determine a similarity between the two. The similarly can be represented by a similarity score.

In some examples, the processor can execute a program, such as SAS Enterprise Miner™, to determine a similarity score between the text of the narratives for two sentiment-pattern groups. The similarity score can be a normalized similarity score between 0 (no similarity) and 1 (identical).

In block 1704, the processor can convert the similarity score into a dissimilarity score. The processor can determine the dissimilarity score by subtracting the similarity score from 1. For example, if the similarity score is 0.7, the dissimilarity score can be 1−0.7=0.3.

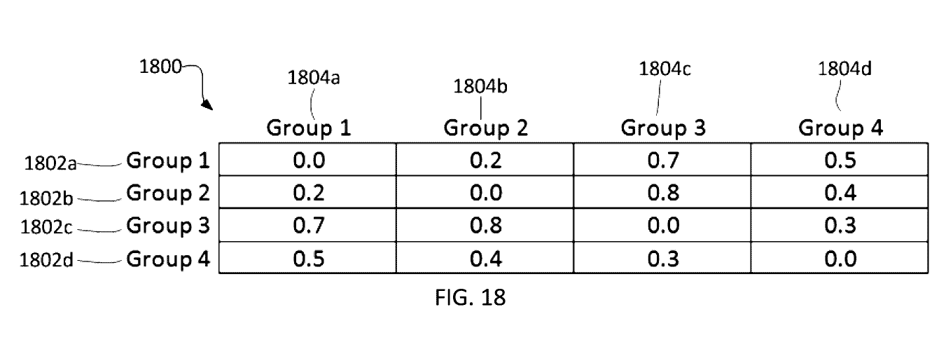

In block 1706, the processor can include the dissimilarity score in a dissimilarity matrix. The dissimilarity matrix can include a matrix of values. Each value in the matrix can indicate a dissimilarity score between two sentiment-pattern groups. The steps of blocks 1702-1706 can be repeated for every combination of sentiment-pattern groups to generate the dissimilarity matrix, an example of which is shown in FIG. 18 as dissimilarity matrix 1800. Dissimilarity matrix 1800 includes multiple rows 1802a-d, with each row 1802a-d corresponding to a particular sentiment pattern group. Likewise, the dissimilarity matrix 1800 includes multiple columns 1804a-d, with each column 1804a-d corresponding to a particular sentiment pattern group. The numerical values in the dissimilarity matrix 1800 represent a dissimilarity score between the two intersecting sentiment pattern groups.

Returning to FIG. 12, in some examples, the dissimilarity matrix can be included within or otherwise used by the multi-layer visualization 1220, as discussed in greater detail with respect to FIGS. 21-22.

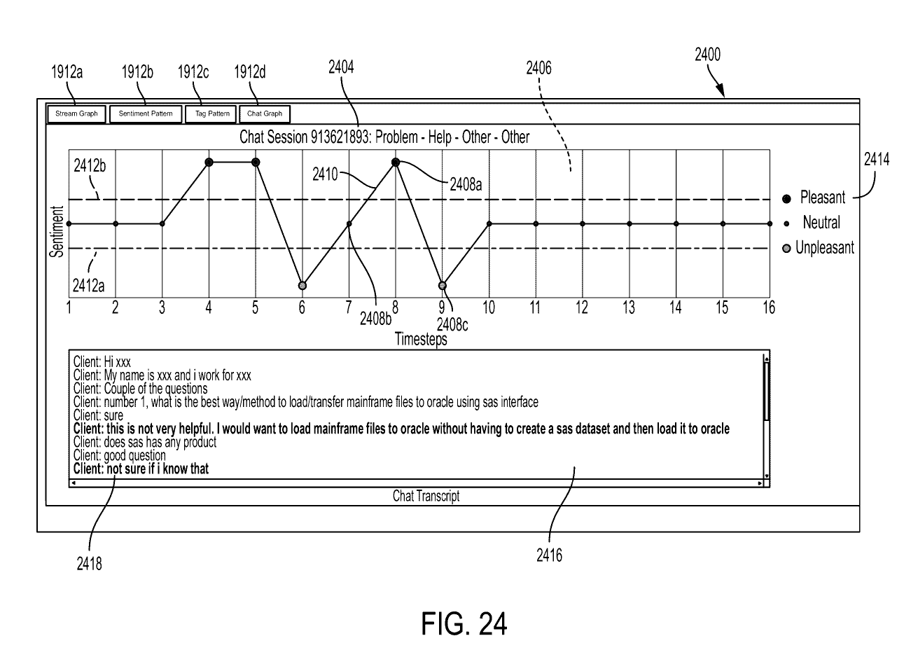

The multi-layer visualization 1220 can include multiple GUI layers through which a user can navigate to obtain varying levels of detail about one or more narratives. Examples of layers of the multi-layer visualization 1220 are described below with respect to FIGS. 19-24. Although the layers shown in FIGS. 19-24 are described as integrated into a single multi-layer visualization 1220, in other examples, the layers shown in FIGS. 19-24 may form one or more separate and independent GUIs. For example, the GUI shown in FIG. 24 may be output independently of the GUIs shown in FIGS. 19-23.

Referring now to FIG. 19, FIG. 19 is an example of a GUI 1900 showing multiple stream graphs 1902a-e associated with topic sets according to some aspects. Each stream 1904 in a respective stream graph 1902a-e can be associated with a particular topic set. For example, one stream in stream graph 1902a can represent a topic set of “Analytics,” another stream in stream graph 1902a can represent a topic set of “Students,” still another stream in stream graph 1902a can represent a topic set of “Guitars,” etc. As another example, one stream in stream graph 1902c can represent a topic set of “Tech Support” and another stream in stream graph 1902c can represent a topic set of “Sales Contracts.”

Each stream graph 1902a-e can be associated with a time period. For example, stream graph 1902a can be associated with the time period between April 1^{st} and April 5^{th}. The stream graph 1902a may include topic sets with narratives that occurred between April 1^{st} and April 5^{th}. As another example, stream graph 1902b can be associated with the time period between April 8^{th} and April 12^{th}. The stream graph 1902b may include topic sets with narratives that occurred between April 8^{th} and April 12^{th}.

The thickness of a stream 1904 at a particular point in time can be based on the number of narratives in the corresponding topic set that occurred at that point in time. For example, the topic set associated with “Students” in stream graph 1902a can include more narratives that occurred on April 1^{st} than the topic set “Analytics.” Accordingly, the stream associated with the topic set “Students” can be thicker on April 1^{st} than the stream associated with the topic set “Analytics.” Conversely, another topic set in stream graph 1902a can include fewer narratives that occurred on April 1^{st} than the topic set “Analytics.” Accordingly, the stream associated with that topic set can be thinner on April 1^{st} than the stream associated with the topic set “Analytics.”

In some examples, one or more of the streams in a stream graph 1902a-d may reduce in thickness as the time period associated with the stream graph 1902a-d approaches a weekend. For example, April 5^{th} may have been a Friday, and April 6^{th}-7^{th} may have been a Saturday and Sunday, respectively. Because fewer narratives may occur on a weekend, the thickness of the streams in stream graph 1902a may reduce as the timeline approaches April 5^{th}, 6^{th}, or 7^{th}.

In some examples, a stream 1904 can include one or more colors, patterns, or other indicators representing the overall sentiment for the corresponding topic set. For example, a particular stream can include a blue color at one point in time, indicating the narratives associated with that stream expressed a generally positive sentiment at that point in time. The stream can additionally or alternatively include a red color at another point in time, indicating the narratives associated with that stream expressed a generally negative sentiment at that point in time. The saturation of the colors can indicate the strength of the sentiment expressed. For example, a more highly saturated blue can indicate a more positive sentiment, and a more highly saturated red can indicate a more negative sentiment. The colors used to represent sentiments can be selected for any number of reasons. For example, because roughly 10% of the population is red-green colorblind, it may be beneficial to select red and blue as the colors used to represent sentiments, rather than red and green. In some examples, the GUI 1900 can include a color bar 1908 or other graphical element signifying to a user the meaning of one or more indicators (e.g., colors) shown in a stream.

The GUI 1900 can include one or more mechanisms for filtering (e.g., manipulating or removing) data displayed in the GUI 1900. For example, the GUI 1900 can include a search bar 1914. The GUI 1900 can receive user input via the search bar indicating a particular topic or keyword. The GUI 1900 can remove data from, add data to, or otherwise manipulate the GUI 1900 based on the particular topic or keyword. For example, the GUI 1900 may highlight a stream corresponding to the particular topic input into the search bar. As another example, stream graphs, streams, or both that do not include narratives having one or more keywords input into the search bar can be removed from or hidden in the GUI 1900.

Additionally or alternatively, the GUI 1900 can include thumbnails or other graphical elements for receiving user input and performing functions using the GUI 1900. For example, the GUI 1900 can include thumbnails 1906 or otherwise compressed versions of the stream graphs 1902a-e. The GUI 1900 can receive a selection of a thumbnail 1910 of a stream graph 1902a and, for example, filter out the other stream graphs 1902b-e from the GUI 1900. In some examples, the GUI 1900 can detect a user interactively drawing a rectangle using a finger or cursor around a portion of a thumbnail 1910 associated with stream graph 1902a. The GUI 1900 can responsively filter out the other stream graphs 1902b-e, or portions of the stream graph 1902a, outside an outer boundary of the rectangle from the GUI 1900. The GUI 1900 can propagate the filtering through one or more other layers of a multi-layer visualization (e.g., such that data of another layer of the multi-layer visualization is filtered correspondingly).

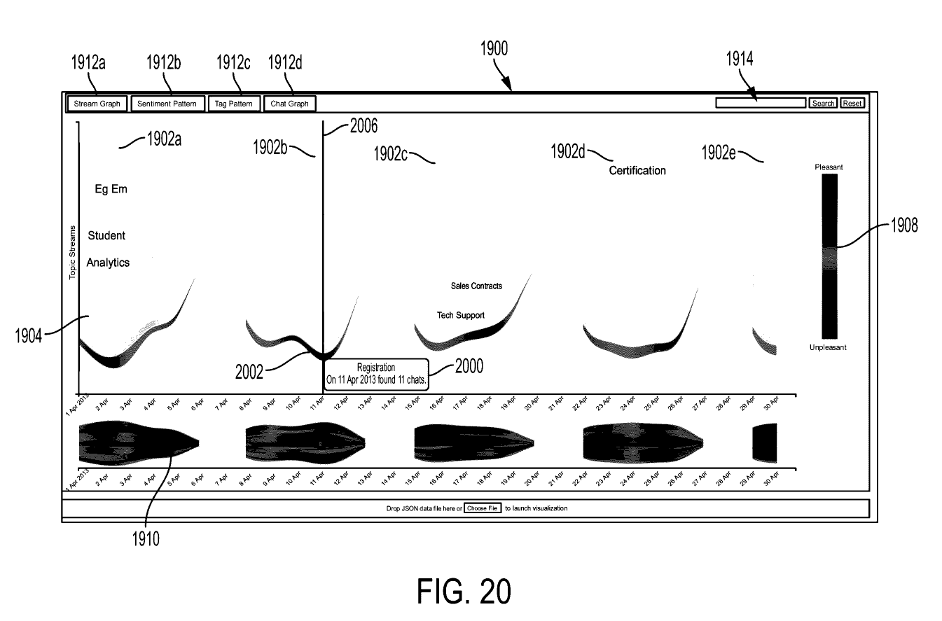

In some examples, the GUI 1900 can detect a user hovering over a stream 1904, such as with a finger or cursor, and output a graphical element associated with the stream 1904. The graphical element can include a tooltip or information bubble. For example, as shown in FIG. 20, the GUI 1900 can detect a user hovering over a particular stream 2002. The GUI 1900 can determine that the user is hovering over the particular stream 2002 at a specific point, such as a point along line 2006, which corresponds to a particular date. The GUI 1900 can responsively output information associated with the particular stream 2002, the particular date, or both. For example, the GUI 1900 can output an information bubble 2000 that includes a topic set associated with the particular stream 2002 (e.g., “Registration”), a number of narratives that occurred on the particular date (e.g., 11), the types of the narratives that occurred on the particular date (e.g., chats), the particular date itself (e.g., “11 Apr. 2013”), or any combination of these.

The GUI 1900 can include one or more buttons 1912a-d or other graphical elements for selectively transitioning between layers of a multi-layer visualization. For example, the GUI 1900 can receive a selection of a button 1912a-d and display another layer of a multi-layer visualization associated with the button. In some examples, the multi-layer visualization may display a different layer in response to a user selecting a particular stream 2002 in a stream graph 1902b. The data displayed in the other layer of the multi-layer visualization may be tailored based on the particular stream 2002 selected. For example, the multi-layer visualization can output the GUI 2100 of FIG. 21 in response to the user selecting stream 2002 of FIG. 20.

Referring now to FIG. 21, FIG. 21 is an example of a GUI 2100 showing sentiment pattern groups 2102a-c associated with a particular topic set according to some aspects. In this example, the sentiment pattern groups 2102a-c are associated with the topic set “Registration.” The sentiment pattern groups 2102a-c displayed in the GUI 2100 can be associated with a particular time period selected in the GUI 1900 of FIG. 19 (e.g., via a user drawing a rectangle around a portion of a thumbnail 1910 associated with the particular time period). For example, the GUI 2100 may only display sentiment pattern groups 2102a-c that include one or more narratives that occurred during the particular time period.

Each sentiment pattern group 2102a-c can be represented by a graphical object, such as a square or rectangle. In some examples, the graphical objects can include colors, textures, patterns, or any combination of these. These features can provide information to a user. For example, the graphical object associated with sentiment pattern group 2102a can include a blue strip representative of a positive sentiment, followed by a red strip representative of a negative sentiment, followed by another blue strip representative of a positive sentiment. A user can view the graphical object associated with sentiment pattern group 2102a and determine, based on the colored strips, that the sentiment pattern for the sentiment pattern group 2102a is “positive, negative, positive.”

As another example, the graphical object associated with sentiment pattern group 2102a can additionally or alternatively include a pattern. The pattern can indicate a particular entity that dominated corresponding portions of narratives within the sentiment pattern group 2102a. The number of lines in each narrative that are attributable to each entity may have been previously counted to determine which entity dominated a particular portion of the conversation. For example, the sentiment pattern group 2102a can include multiple chat logs between corporate representatives and customers about a particular product. The graphical object representing sentiment pattern group 2102a can include a dotted pattern over the first blue strip representing the first positive sentiment. The dotted pattern can indicate that the corporate representative dominated the corresponding portions of the narratives that had the first positive sentiment. The graphical object can also include a striped pattern over the red strip representing the negative sentiment. The striped pattern can indicate that the customer dominated the corresponding portions of the narratives that had the negative sentiment. The graphical object can include a dotted pattern over the second blue strip representing the second positive sentiment. The dotted pattern can indicate that the corporate representative dominated the corresponding portions of the narratives that had the second positive sentiment. This patterning may allow a user viewing the GUI 2100 to quickly identify which entity is associated with the different sentiments in the sentiment pattern group 2102a. In some examples, the GUI 2100 can include a color bar 2106, a legend 2108, or another graphical element to aid the user in determining the meaning of one or more features of a graphical object.

In some examples, the sizes or shapes of the graphical objects representing the sentiment pattern groups 2102a-c can indicate the number of narratives within the sentiment pattern groups 2102a-c. For example, a graphical object representative of sentiment pattern group 2102a can have a larger length, width, or both than another graphical object representative of sentiment pattern group 2102c, because sentiment pattern group 2102a may include more narratives than sentiment pattern group 2102c. Additionally or alternatively, the graphical objects representing the sentiment pattern groups 2102a-c can include the numbers of narratives within the sentiment pattern groups 2102a-c. For example, the graphical object representing sentiment pattern group 2102a can include the number 2104 of narratives in the sentiment pattern group 2102a, which in this example is 222.

The spatial positioning in the GUI 2100 of the graphical objects representing the sentiment pattern groups 2102a-c can be based on the similarity, or dissimilarity, between the narratives in the sentiment pattern groups 2102a-c. For example, a dissimilarity matrix can be used to determine that sentiment pattern group 2102c is more dissimilar from sentiment pattern group 2102a than sentiment pattern group 2102b. In such an example, the GUI 2100 can display sentiment pattern group 2102b as spatially closer to sentiment pattern group 2102a than sentiment pattern group 2102c.

In some examples, the GUI 2100 can detect a user hovering over a sentiment pattern group 2102a-c, such as with a finger or cursor, and output a graphical element associated with the sentiment pattern group 2102a-c. The graphical element can include a tooltip or information bubble. For example, as shown in FIG. 22, the GUI 2100 can detect a user hovering over a particular sentiment pattern group 2202. The GUI 2100 can responsively output information associated with the particular sentiment pattern group 2202. For example, the GUI 2100 can output an information bubble 2204 that includes the sentiment pattern (e.g., “PUP” or “pleasant, unpleasant, pleasant”) associated with the sentiment pattern group 2202, the number of narratives in the sentiment pattern group 2202, a percentage of narratives in the sentiment pattern group 2202 relative to all of the narratives for the topic set, an average length (e.g., in characters, words, or sentences) of the narratives in the sentiment pattern group 2202, a type of one or more narratives in the sentiment pattern group 2202 (e.g., chats), or any combination of these.

In some examples, the multi-layer visualization may display a different layer in response to a user selecting a particular sentiment pattern group 2202 from the GUI 2100. The data displayed in the other layer of the multi-layer visualization may be tailored based on the particular sentiment pattern group 2202 selected. For example, the multi-layer visualization can output the GUI 2300 of FIG. 23 in response to the user selecting sentiment pattern group 2202 of FIG. 22.

Referring now to FIG. 23, FIG. 23 is an example of a GUI 2300 showing semantic patterns associated with narratives in a particular sentiment pattern group according to some aspects. In this example, all of the narratives have the sentiment pattern “positive, negative, positive” because sentiment pattern group 2202 of FIG. 22 was selected to transition to the multi-layer visualization to GUI 2300, and sentiment pattern group 2202 has the sentiment pattern “positive, negative, positive.”

In some examples, graphical objects representing narratives can be displayed in GUI 2300. The graphical objects can be grouped by semantic tag pattern. For example, graphical object 2304a can represent one narrative, and graphical object 2304b can represent another narrative. The graphical objects 2304a-b can be grouped together in box 2302 because the corresponding narratives can have the same semantic tag pattern (“Request Info,” “Help,” “Help”). The groupings of graphical objects can be displayed in a scrollable window, which can include a scroll bar 2312 for allowing a user to scroll among the groupings of graphical objects. The GUI 2300 can sort and display the groupings of the graphical objects from the groupings with the most graphical objects to the least graphical objects. For example, the GUI 2300 can display a grouping of five graphical objects first, followed by a grouping of four graphical objects, followed by a grouping of three graphical objects, etc. Thus, groupings associated with more narratives can be at the top and groupings associated with fewer narratives can be at the bottom.

The GUI 2300 can display a semantic tag 2306 corresponding to a particular sentiment block of a graphical object. The semantic tag 2306 can indicate the subject-matter of the content associated with the sentiment block. For example, the GUI 2300 can display the semantic tag “Request Info” visually linked to a positive sentiment block of graphical object 2304a. The GUI 2300 can display the semantic tag “Help” visually linked to a negative sentiment block of graphical object 2304a. The semantic tags 2306 may allow a user to quickly identify the subject-matter of one or more corresponding sentiment blocks or narratives.

The lengths of the graphical objects can indicate the lengths of the corresponding narratives (e.g., in lines or sentences). For example, the graphical object 2304a can have a longer length than graphical object 2304b because the graphical object 2304a can represent a narrative with more sentences than a narrative represented by graphical object 2304b. This may allow a user to quickly compare the lengths of two or more corresponding narratives.

In some examples, the GUI 2300 can include a histogram 2308. An X-axis of the histogram 2308 can include bars representing particular semantic tag patterns. Each bar can represent a different semantic tag pattern. The height of the bars along the Y-axis can indicate a number of narratives having the particular semantic tag pattern.

In some examples, the GUI 2300 can detect a user hovering over a bar on the histogram 2308 and output a graphical element associated with the bar. The graphical element can include a tooltip or information bubble. For example, the GUI 2300 can detect a user hovering over a bar 2314. The GUI 2300 can responsively output information associated with the bar 2314. For example, the GUI 2300 can output an information bubble 2310 that includes the semantic tag pattern (e.g., “REQUEST INFO->HELP->HELP”) associated with the bar 2314, a number of narratives (e.g., 2) that have the semantic tag pattern, a type of the narratives (e.g., chats) that have the semantic tag pattern, or any combination of these.

In some examples, the GUI 2300 can detect a user selecting a particular bar from the histogram 2308. The GUI 2300 can responsively cause the scrollable window to scroll until a grouping of graphical objects corresponding to the bar of the histogram 2308 is displayed. For example, the GUI 2300 can detect a user selecting a bar for the semantic tag pattern of “Help, Question, Solution,” and responsively scroll the scrollable window until a grouping of graphical objects having the semantic tag pattern “Help, Question, Solution” is displayed.

In some examples, the multi-layer visualization may display a different layer in response to a user selecting a particular graphical object 2304a-b from the GUI 2300. The data displayed in the other layer of the multi-layer visualization may be tailored based on the particular graphical object 2304a-b selected. For example, the multi-layer visualization can output the GUI 2400 of FIG. 24 in response to the user selecting a graphical object having a semantic tag pattern of “Problem, Help, Other, Other.”

Referring now to FIG. 24, FIG. 24 is an example of a GUI 2400 showing sentiments of a specific narrative within a particular sentiment pattern group according to some aspects. In some examples, any feature or combination of features discussed with respect to FIGS. 8-11 can be used to implement GUI 2400.

In this example, the narrative includes a chat session between two users (e.g., the entirety of which can make up the narrative). The two users can include a customer of a company and a representative of the company. The GUI 2400 can include a graph 2406 visually indicating one or more sentiments associated with one or more portions of the chat session. For example, each point on the graph 2406 can correspond to a line or sentence of the chat session and represent a positive sentiment, a negative sentiment, or a neutral sentiment.

The graph 2406 can include a timeline along the X-axis and a sentiment value along the Y-axis. As shown in FIG. 24, the timeline can include segment numbers (e.g., the first segment can be at time 1, the second segment can be at time 2, etc.). In other examples, the time along the X-axis can include a time that the segment was created. For example, the time along the X-axis can include timestamps indicating when each sentence in the chat session was typed. This can provide a user with information, such as how long each sentence took to type during the chat session or the duration of delays between responses by participants in the chat.

In some examples, each point on the graph 2406 can include a shape. The shape can be a circle, square, rectangle, triangle, or other shape. In some examples, the shape can indicate a source of a corresponding segment. For example, a triangle-shaped point can indicate that a corresponding sentence of the chat session was typed by the customer. A circle-shaped point can indicate that a corresponding sentence of the chat session was typed by the representative of the company. In some examples, a color of the shape can represent a particular sentiment associated with the shape (e.g., as designated by a legend 2414).

The GUI 2400 can visually indicate at least one transition between at least two sentiments. For example, the graph 2406 can visually indicate a transition 2410 between point 2408b and point 2408a. This transition 2410 can visually represent a transition between a neutral sentiment (e.g., as indicated by point 2408b) and a positive sentiment (e.g., as indicated by point 2408a). The graph 2406 can allow the user to visually determine a flow of sentiments associated with the chat session over time and identify locations in this chat session where the sentiment changes, where the sentiment varies rapidly, where the sentiment remains constant, or any combination of these.

In some examples, the GUI 2400 can include a lower boundary 2412a, an upper boundary 2412b, or both indicating a range of values. In one example, points above the range of values, such as point 2408a, can represent a pleasant or positive sentiment. Points within the range, such as 2408b, can represent a neutral sentiment. Points below the range of values can represent an unpleasant or negative sentiment.

In some examples, the GUI 2400 can include at least a portion of the chat session transcript 2418. The portion of the chat session transcript 2418 can be positioned in a scrollable window or frame 2416. In some examples, each line in the chat session transcript 2418 can be color coded or otherwise visually indicate whether the line is associated with a positive sentiment, a negative sentiment, or a neutral sentiment (e.g., via italicized, regular, or bold font, respectively). This can allow the user to visually determine a sentiment associated with a particular portion of the chat session transcript quickly. The GUI 2400 can additionally or alternatively include other information 2404, such as a customer number, a chat session number, a problem characterization, a status, etc.

In some examples, GUI 2400 can combine multiple sources and types of information into a single visualization that is easy to understand for users. For example, a sentiment can be represented by a color and/or position of a point 2408a on a graph 2406, and a provider of the sentiment (e.g. a customer or representative in a chat) can be represented by a shape of the point 2408a (e.g. circle, square, triangle, and so on). This may allow a user to see both the sentiment and the segment's provider in a single visualization. This can reduce the need for extensive training for users to understand and explore the sentiment analysis results.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A non-transitory computer readable medium comprising program code executable by a processor for causing the processor to:
receive an electronic communication comprising a plurality of narratives;
segment each narrative of the plurality of narratives into respective blocks of characters;
determine a plurality of sentiments associated with the respective blocks of characters using a sentiment dictionary, each sentiment of the plurality of sentiments corresponding to a particular block of characters;
determine a plurality of sentiment patterns based on the plurality of sentiments, each sentiment pattern of the plurality of sentiment patterns corresponding to a respective narrative of the plurality of narratives and comprising a plurality of sentiment blocks ordered in an arrangement corresponding to the respective blocks of characters associated with the respective narrative, wherein each sentiment block of the plurality of sentiment blocks indicates one or more sentiments of the plurality of sentiments;
determine a plurality of semantic tags associated with the plurality of sentiment patterns, each semantic tag of the plurality of semantic tags corresponding to a respective sentiment block of the plurality of sentiment blocks and representative of content associated with the respective sentiment block;
categorize the plurality of narratives into a plurality of topic sets, each topic set of the plurality of topic sets comprising one or more narratives having a common topic;
determine a plurality of overall sentiments based on the plurality of topic sets, each overall sentiment of the plurality of overall sentiments corresponding to a respective topic set of the plurality of topic sets and indicating a total sentiment among one or more narratives associated with the respective topic set;
categorize the plurality of sentiment patterns into a plurality of sentiment pattern groups, each sentiment pattern group of the plurality of sentiment pattern groups associated with a unique sentiment pattern of the plurality of sentiment patterns;
determine a similarity between at least two sentiment pattern groups of the plurality of sentiment pattern groups; and
transmit graphical information configured to cause a display to output a graphical user interface visually indicating at least a portion of: the plurality of sentiments, the plurality of sentiment pattern groups, the plurality of semantic tags, or the plurality of topic sets.

2. The non-transitory computer readable medium of claim 1, further comprising program code executable by the processor for causing the processor to:
determine the plurality of sentiments associated with the respective blocks of characters using the sentiment dictionary by:
accessing the sentiment dictionary;
identifying one or more expressions in a respective block of characters that are in the sentiment dictionary;
mapping the one or more expressions in the respective block to one or more corresponding sentiment values using the sentiment dictionary;
determining a respective total sentiment score for the respective block of characters by aggregating the one or more corresponding sentiment values; and
determining a respective sentiment for the respective block of characters based on the total sentiment score.

3. The non-transitory computer readable medium of claim 1, further comprising program code executable by the processor for causing the processor to:
determine the plurality of sentiment patterns based on the plurality of sentiments by:
arranging a respective plurality of sentiments associated with a particular narrative in a predetermined order to produce a sentiment pattern associated with the narrative; and
combining adjacent sentiments that are of the same type in the sentiment pattern to reduce a length of the sentiment pattern.

4. The non-transitory computer readable medium of claim 1, further comprising program code executable by the processor for causing the processor to:
determine the plurality of semantic tags associated with the plurality of sentiment patterns by:
constructing a training data set for training a classification system;
training the classification system using the training data set;
using a respective plurality of sentiment blocks corresponding to a respective sentiment pattern as input for the classification system; and
receiving, as output from the classification system, a multitude of semantic tags associated with the respective semantic pattern.

5. The non-transitory computer readable medium of claim 1, further comprising program code executable by the processor for causing the processor to:
determine the plurality of overall sentiments based on the plurality of topic sets by:
selecting a subset of narratives associated with a respective topic set;
generating a first plurality of overall sentiment values by determining an overall sentiment value for each narrative of the subset of narratives;
training a classification system using the subset of narratives and the first plurality of overall sentiment values;
determining, using the classification system, a second plurality of overall sentiment values for a remainder of the narratives associated with the respective topic set; and
determining the overall sentiment for the respective topic set based on the first plurality of overall sentiment values and the second plurality of overall sentiment values.

6. The non-transitory computer readable medium of claim 1, further comprising program code executable by the processor for causing the processor to:
determine the similarity between the at least two sentiment pattern groups of the plurality of sentiment pattern groups by:
assigning each narrative of the plurality of narratives to a respective sentiment pattern group based on a respective sentiment pattern associated with the narrative;
determining a similarity score for the at least two sentiment pattern groups;
converting the similarity score to a dissimilarity score; and
including the dissimilarity score in a dissimilarity matrix.

7. The non-transitory computer readable medium of claim 1, further comprising program code executable by the processor for causing the processor to:
display a first layer of the graphical user interface that visually indicates the plurality of topic sets and the overall sentiment for each topic set of the plurality of topic sets using a stream graph.

8. The non-transitory computer readable medium of claim 7, further comprising program code executable by the processor for causing the processor to:
in response to a first selection of a topic set of the plurality of topic sets, display a second layer of the graphical user interface that visually indicates the at least two sentiment pattern groups and the similarity between the at least two sentiment pattern groups.

9. The non-transitory computer readable medium of claim 8, further comprising program code executable by the processor for causing the processor to:
in response to a second selection of a sentiment pattern group of the at least two sentiment pattern groups, display a third layer of the graphical user interface that visually indicates at least two semantic tags corresponding to one or more narratives.

10. The non-transitory computer readable medium of claim 9, further comprising program code executable by the processor for causing the processor to:
in response to a third selection of a particular narrative of the one or more narratives, display a fourth layer of the graphical user interface that includes a line graph comprising a plurality of points associated with a multitude of sentiments expressed in the particular narrative, at least two points of the plurality of points indicating a transition between at least two different sentiments of the multitude of sentiments expressed in the particular narrative.

11. A method comprising:
receiving an electronic communication comprising a plurality of narratives;
segmenting each narrative of the plurality of narratives into respective blocks of characters;
determining a plurality of sentiments associated with the respective blocks of characters using a sentiment dictionary, each sentiment of the plurality of sentiments corresponding to a particular block of characters;
determining a plurality of sentiment patterns based on the plurality of sentiments, each sentiment pattern of the plurality of sentiment patterns corresponding to a respective narrative of the plurality of narratives and comprising a plurality of sentiment blocks ordered in an arrangement corresponding to the respective blocks of characters associated with the respective narrative, wherein each sentiment block of the plurality of sentiment blocks indicates one or more sentiments of the plurality of sentiments;
determining a plurality of semantic tags associated with the plurality of sentiment patterns, each semantic tag of the plurality of semantic tags corresponding to a respective sentiment block of the plurality of sentiment blocks and representative of content associated with the respective sentiment block;
categorizing the plurality of narratives into a plurality of topic sets, each topic set of the plurality of topic sets comprising one or more narratives having a common topic;
determining a plurality of overall sentiments based on the plurality of topic sets, each overall sentiment of the plurality of overall sentiments corresponding to a respective topic set of the plurality of topic sets and indicating a total sentiment among one or more narratives associated with the respective topic set;
categorizing the plurality of sentiment patterns into a plurality of sentiment pattern groups, each sentiment pattern group of the plurality of sentiment pattern groups associated with a unique sentiment pattern of the plurality of sentiment patterns;
determining a similarity between at least two sentiment pattern groups of the plurality of sentiment pattern groups; and
displaying a graphical user interface visually indicating at least a portion of: the plurality of sentiments, the plurality of sentiment pattern groups, the plurality of semantic tags, or the plurality of topic sets.

12. The method of claim 11, further comprising:
determining the plurality of sentiments associated with the respective blocks of characters using the sentiment dictionary by:
accessing the sentiment dictionary;
identifying one or more expressions in a respective block of characters that are in the sentiment dictionary;
mapping the one or more expressions in the respective block to one or more corresponding sentiment values using the sentiment dictionary;
determining a respective total sentiment score for the respective block of characters by aggregating the one or more corresponding sentiment values; and
determining a respective sentiment for the respective block of characters based on the total sentiment score.

13. The method of claim 11, further comprising:
determining the plurality of sentiment patterns based on the plurality of sentiments by:
arranging a respective plurality of sentiments associated with a particular narrative in a predetermined order to produce a sentiment pattern associated with the narrative; and
combining adjacent sentiments that are of the same type in the sentiment pattern to reduce a length of the sentiment pattern.

14. The method of claim 11, further comprising:
determining the plurality of semantic tags associated with the plurality of sentiment patterns by:
constructing a training data set for training a classification system;
training the classification system using the training data set;
using a respective plurality of sentiment blocks corresponding to a respective sentiment pattern as input for the classification system; and
receiving, as output from the classification system, a multitude of semantic tags associated with the respective semantic pattern.

15. The method of claim 11, further comprising:
determining the plurality of overall sentiments based on the plurality of topic sets by:
selecting a subset of narratives associated with a respective topic set;
generating a first plurality of overall sentiment values by determining an overall sentiment value for each narrative of the subset of narratives;
training a classification system using the subset of narratives and the first plurality of overall sentiment values;
determining, using the classification system, a second plurality of overall sentiment values for a remainder of the narratives associated with the respective topic set; and
determining the overall sentiment for the respective topic set based on the first plurality of overall sentiment values and the second plurality of overall sentiment values.

16. The method of claim 11, further comprising:
determining the similarity between the at least two sentiment pattern groups of the plurality of sentiment pattern groups by:
assigning each narrative of the plurality of narratives to a respective sentiment pattern group based on a respective sentiment pattern associated with the narrative;
determining a similarity score for the at least two sentiment pattern groups;
converting the similarity score to a dissimilarity score; and
including the dissimilarity score in a dissimilarity matrix.

17. The method of claim 11, further comprising:
displaying a first layer of the graphical user interface that visually indicates the plurality of topic sets and the overall sentiment for each topic set of the plurality of topic sets using a stream graph.

18. The method of claim 17, further comprising:
in response to a first selection of a topic set of the plurality of topic sets, displaying a second layer of the graphical user interface that visually indicates the at least two sentiment pattern groups and the similarity between the at least two sentiment pattern groups.

19. The method of claim 18, further comprising:
in response to a second selection of a sentiment pattern group of the at least two sentiment pattern groups, displaying a third layer of the graphical user interface that visually indicates at least two semantic tags corresponding to one or more narratives.

20. The method of claim 19, further comprising:
in response to a third selection of a particular narrative of the one or more narratives, displaying a fourth layer of the graphical user interface that includes a line graph comprising a plurality of points associated with a multitude of sentiments expressed in the particular narrative, at least two points of the plurality of points indicating a transition between at least two different sentiments of the multitude of sentiments expressed in the particular narrative.

21. A system comprising:
a processing device; and
a memory device in which instructions executable by the processing device are stored for causing the processing device to:
receive an electronic communication comprising a plurality of narratives;
segment each narrative of the plurality of narratives into respective blocks of characters;
determine a plurality of sentiments associated with the respective blocks of characters using a sentiment dictionary, each sentiment of the plurality of sentiments corresponding to a particular block of characters;
determine a plurality of sentiment patterns based on the plurality of sentiments, each sentiment pattern of the plurality of sentiment patterns corresponding to a respective narrative of the plurality of narratives and comprising a plurality of sentiment blocks ordered in an arrangement corresponding to the respective blocks of characters associated with the respective narrative, wherein each sentiment block of the plurality of sentiment blocks indicates one or more sentiments of the plurality of sentiments;
determine a plurality of semantic tags associated with the plurality of sentiment patterns, each semantic tag of the plurality of semantic tags corresponding to a respective sentiment block of the plurality of sentiment blocks and representative of content associated with the respective sentiment block;
categorize the plurality of narratives into a plurality of topic sets, each topic set of the plurality of topic sets comprising one or more narratives having a common topic;
determine a plurality of overall sentiments based on the plurality of topic sets, each overall sentiment of the plurality of overall sentiments corresponding to a respective topic set of the plurality of topic sets and indicating a total sentiment among one or more narratives associated with the respective topic set;
categorize the plurality of sentiment patterns into a plurality of sentiment pattern groups, each sentiment pattern group of the plurality of sentiment pattern groups associated with a unique sentiment pattern of the plurality of sentiment patterns;
determine a similarity between at least two sentiment pattern groups of the plurality of sentiment pattern groups; and
transmit graphical information configured to cause a display to output a graphical user interface visually indicating at least a portion of: the plurality of sentiments, the plurality of sentiment pattern groups, the plurality of semantic tags, or the plurality of topic sets.

22. The system of claim 21, wherein the memory device further comprises instructions executable by the processing device for causing the processing device to:
determine the plurality of sentiments associated with the respective blocks of characters using the sentiment dictionary by:
accessing the sentiment dictionary;
identifying one or more expressions in a respective block of characters that are in the sentiment dictionary;
mapping the one or more expressions in the respective block to one or more corresponding sentiment values using the sentiment dictionary;
determining a respective total sentiment score for the respective block of characters by aggregating the one or more corresponding sentiment values; and
determining a respective sentiment for the respective block of characters based on the total sentiment score.

23. The system of claim 21, wherein the memory device further comprises instructions executable by the processing device for causing the processing device to:
determine the plurality of sentiment patterns based on the plurality of sentiments by:
arranging a respective plurality of sentiments associated with a particular narrative in a predetermined order to produce a sentiment pattern associated with the narrative; and
combining adjacent sentiments that are of the same type in the sentiment pattern to reduce a length of the sentiment pattern.

24. The system of claim 21, wherein the memory device further comprises instructions executable by the processing device for causing the processing device to:
determine the plurality of semantic tags associated with the plurality of sentiment patterns by:
constructing a training data set for training a classification system;
training the classification system using the training data set;
using a respective plurality of sentiment blocks corresponding to a respective sentiment pattern as input for the classification system; and
receiving, as output from the classification system, a multitude of semantic tags associated with the respective semantic pattern.

25. The system of claim 21, wherein the memory device further comprises instructions executable by the processing device for causing the processing device to:
determine the plurality of overall sentiments based on the plurality of topic sets by:
selecting a subset of narratives associated with a respective topic set;
generating a first plurality of overall sentiment values by determining an overall sentiment value for each narrative of the subset of narratives;
training a classification system using the subset of narratives and the first plurality of overall sentiment values;
determining, using the classification system, a second plurality of overall sentiment values for a remainder of the narratives associated with the respective topic set; and
determining the overall sentiment for the respective topic set based on the first plurality of overall sentiment values and the second plurality of overall sentiment values.

26. The system of claim 21, wherein the memory device further comprises instructions executable by the processing device for causing the processing device to:
determine the similarity between the at least two sentiment pattern groups of the plurality of sentiment pattern groups by:
assigning each narrative of the plurality of narratives to a respective sentiment pattern group based on a respective sentiment pattern associated with the narrative;
determining a similarity score for the at least two sentiment pattern groups;
converting the similarity score to a dissimilarity score; and
including the dissimilarity score in a dissimilarity matrix.

27. The system of claim 21, wherein the memory device further comprises instructions executable by the processing device for causing the processing device to:
display a first layer of the graphical user interface that visually indicates the plurality of topic sets and the overall sentiment for each topic set of the plurality of topic sets using a stream graph.

28. The system of claim 27, wherein the memory device further comprises instructions executable by the processing device for causing the processing device to:
in response to a first selection of a topic set of the plurality of topic sets, display a second layer of the graphical user interface that visually indicates the at least two sentiment pattern groups and the similarity between the at least two sentiment pattern groups.

29. The system of claim 28, wherein the memory device further comprises instructions executable by the processing device for causing the processing device to:
in response to a second selection of a sentiment pattern group of the at least two sentiment pattern groups, display a third layer of the graphical user interface that visually indicates at least two semantic tags corresponding to one or more narratives.

30. The system of claim 29, wherein the memory device further comprises instructions executable by the processing device for causing the processing device to:
in response to a third selection of a particular narrative of the one or more narratives, display a fourth layer of the graphical user interface that includes a line graph comprising a plurality of points associated with a multitude of sentiments expressed in the particular narrative, at least two points of the plurality of points indicating a transition between at least two different sentiments of the multitude of sentiments expressed in the particular narrative.
